(19) United States
(12) Patent Application Publication
(10) Pub. No.: US 2022/0106172 A1
(43) Pub. Date: Apr. 7, 2022

(54) Floor Jack

(71) Applicant: Harry Gottlieb Harding, IV, Alloway, NJ (US)

(72) Inventor: Harry Gottlieb Harding, IV, Alloway, NJ (US)

(21) Appl. No.: 17/483,850

(22) Filed: Sep. 24, 2021

Related U.S. Application Data
(60) Provisional application No. 63/086,607, filed on Oct. 2, 2020.

(51) Int. Cl. B66F 5/04

(52) U.S. Cl. CPC B66F 5/04

(57) ABSTRACT

A floor jack and a frame therefor including a pair of arched side plates, hubs, axles, and spreader bars are provided. A first pair and a second pair of hubs are positioned at front ends and rear ends of the arched side plates respectively. A first axle and a second axle connect the arched side plates to the first pair and the second pair of hubs at the front ends and the rear ends of the arched side plates, respectively, using pairs of adjustable collars that pivot between lower and upper positions. The spreader bars separate the arched side plates along their length. The frame is configured for use in a conventional jack or in a mega jack with increased elevation by fixing the axles to the lower or upper positions of the adjustable collars. A frame is also provided for a fixed height floor jack including non-adjustable collars.

### CROSS-REFERENCE TO RELATED APPLICATIONS

This application claims priority to and the benefit of the provisional patent application titled “Structure For A Floor Jack”, application No. 63/086,607, filed in the United States Patent and Trademark Office on Oct. 2, 2020. The specification of the above referenced patent application is incorporated herein by reference in its entirety.

### BACKGROUND

The apparatus disclosed herein, in general, relates to a floor jack. More particularly, the apparatus disclosed herein relates to a floor jack and a frame therefor that allows a lifting pad of the floor jack to be elevated, for example, to about 40 inches above a substantially horizontal surface on which the floor jack is positioned, without the aid of an add-on extension.

The structures of side plates, hubs, axles, and spreader bars, and the type of tires and wheels attached to the hubs, determine the height to which the lifting pad of the floor jack can be elevated above a substantially horizontal surface on which the floor jack is positioned, and the weight that the floor jack can support.

There is a long felt need for a floor jack and a frame therefor that allows the lifting pad of the floor jack to be raised to an elevation more than the elevation that lifting pads can be raised with conventional floor jacks.

### SUMMARY

This summary is provided to introduce a selection of concepts in a simplified form that are further disclosed in the detailed description. This summary is not intended to determine the scope of the claimed subject matter.

The apparatus disclosed herein addresses the above-recited need for a floor jack and a frame therefor that allows a lifting pad of the floor jack to be raised to an elevation more than the elevation that lifting pads can be raised with conventional floor jacks. The frame disclosed herein comprises a pair of arched side plates, a first pair of hubs, a second pair of hubs, a first axle, a second axle, and a set of spreader bars. Each of the arches side plates comprises a front end and a rear end. In an embodiment, the pair of arched side plates is made of metal and is powder coated. The first pair of hubs is positioned at the front end of the pair of arched side plates. The second pair of hubs is positioned at the rear ends of the pair of arched side plates. In an embodiment, each hub of the first pair of hubs and the second pair of hubs comprises a four-bolt flange bearing, a spacer plate, and an end plate coaxially positioned on either end of the first axle and the second axle respectively.

The first axle connects the pair of arched side plates to the first pair of hubs at the front ends using a first pair of adjustable collars. The second axle connects the pair of arched side plates to the second pair of hubs at the rear ends using a second pair of adjustable collars. In an embodiment, the first pair of adjustable collars and the second pair of adjustable collars are teardrop-shaped adjustable shaft collars. The teardrop-shaped adjustable shaft collars are configured to adjust an elevation of a lifting pad of the floor jack, above a substantially horizontal surface on which the floor jack is positioned, between a lowered position and a fully extended position. Each of the teardrop-shaped adjustable shaft collars pivots about a pivot point to switch between a lower position and an upper position, to adjust the elevation of the lifting pad of the floor jack. Each of the arched side plates comprises upper axle holes and lower axle holes corresponding to the upper position and the lower position of the teardrop-shaped adjustable shaft collars respectively, to allow adjustment of the elevation of the lifting pad of the floor jack. The set of spreader bars separate the pair of arched side plates along a length of the pair of arched side plates.

In an embodiment, the frame disclosed herein further comprises a set of tire-wheel assemblies. One of the tire-wheel assemblies is connected to each hub of the first pair of hubs and the second pair of hubs to provide mobility to the floor jack when the floor jack is assembled.

The teardrop-shaped adjustable shaft collars allow the lifting pad to be raised, for example, to about 10½ inches above the substantially horizontal surface on which the floor jack is positioned. The diameter of a wheel on the floor jack ranges, for example, from about 3½ inches to about 25½ inches. The minimum height the lifting pad with a 3½-inch diameter wheel can be elevated is, for example, about 14¼ inches above the substantially horizontal surface on which the floor jack is positioned, and the maximum height the lifting pad can be elevated is, for example, about 29¾ inches, when the lifting pad is in a retracted position. For example, with a 25½-inch diameter wheel, the minimum elevation of the lifting pad, above the substantially horizontal surface on which the floor jack is positioned, is about 25¼ inches, and the maximum elevation of the lifting pad, above the substantially horizontal surface on which the floor jack is positioned, is about 40¾ inches. In both the configurations, the lifting pad is in a retracted position.

In an embodiment, a frame is provided for a fixed height floor jack. In this embodiment, non-adjustable fixed shaft collars are used in lieu of the adjustable shaft collars. In this embodiment, the frame comprises a pair of arched side plates, a first pair of hubs, a second pair of hubs, a first axle, a second axle, and a set of spreader bars as disclosed above. In this embodiment, the pair of arched side plates is made of thick metal and is powder coated. In this embodiment, the first axle connects the pair of arched side plates to the first pair of hubs at the front ends using a first pair of non-adjustable collars, while the second axle connects the pair of arched side plates to the second pair of hubs at the rear ends using a second pair of non-adjustable collars.

The floor jack in the above embodiments comprises a lifting mechanism. The lifting mechanism comprises a lifting pad positioned between the pair of arched side plates. The lifting mechanism further comprises a handle operably connected to the pair of arched side plates and configured to raise the lifting pad to an extended position or lower the lifting pad to a lowered position or a retracted position.

### BRIEF DESCRIPTION OF THE DRAWINGS

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific structures and components disclosed herein. The description of a structure or a component referenced by a numeral in a drawing is applicable to the description of that structure or component shown by that same numeral in any subsequent drawing herein.

FIG. 1 is a tabulation of different parts of a frame for a floor jack, according to a first embodiment herein.

FIG. 2 exemplarily illustrates a top view of the frame of the floor jack, according to the first embodiment herein.

FIG. 3 exemplarily illustrates a side view of the frame of the floor jack, according to the first embodiment herein.

FIG. 4 exemplarily illustrates a rear view of the frame of the floor jack, according to the first embodiment herein.

FIG. 5 exemplarily illustrates a perspective view of the frame of the floor jack configured in an upper position, according to the first embodiment herein.

FIG. 6 exemplarily illustrates a perspective view of the frame of the floor jack configured in a lower position, according to the first embodiment herein.

FIG. 7 exemplarily illustrates an exploded view of the frame of the floor jack, according to the first embodiment herein.

FIG. 8A exemplarily illustrates a perspective view of the frame of the floor jack in the upper position, showing a lifting mechanism of the floor jack, according to the first embodiment herein.

FIG. 8B exemplarily illustrates a perspective view of the frame of the floor jack shown in FIG. 8A, showing the lifting mechanism in an extended position, according to the first embodiment herein.

FIG. 9A exemplarily illustrates a perspective view of the frame of the floor jack in the lower position, showing the lifting mechanism, according to the first embodiment herein.

FIG. 9B exemplarily illustrates a perspective view of the frame of the floor jack shown in FIG. 9A, showing the lifting mechanism in an extended position, according to the first embodiment herein.

FIG. 10A exemplarily illustrates a front perspective view of the floor jack comprising the frame, the lifting mechanism, and tire-wheel assemblies, according to the first embodiment herein.

FIG. 10B exemplarily illustrates a rear perspective view of the floor jack comprising the frame, the lifting mechanism, and tire-wheel assemblies, according to the first embodiment herein.

FIG. 11 exemplarily illustrates an exploded view of the floor jack, showing integration of the lifting mechanism in the frame of the floor jack, according to the first embodiment herein.

FIG. 12 exemplarily illustrates a dimensional drawing of an arched side plate of the frame of the floor jack, according to the first embodiment herein.

FIG. 13 exemplarily illustrates a dimensional drawing of an axle of the frame of the floor jack, according to the first embodiment herein.

FIG. 14 exemplarily illustrates a dimensional drawing of a spreader bar of the frame of the floor jack, according to the first embodiment herein.

FIG. 15A exemplarily illustrates a dimensional drawing of an adjustable collar of the frame of the floor jack, according to the first embodiment herein.

FIG. 15B exemplarily illustrates positional settings of the adjustable collar of the frame of the floor jack, according to the first embodiment herein.

FIG. 16 exemplarily illustrates a dimensional drawing of a four-bolt flange bearing of each hub of the frame of the floor jack, according to the first embodiment herein.

FIG. 17 exemplarily illustrates a dimensional drawing of a spacer plate of each hub of the frame of the floor jack, according to the first embodiment herein.

FIG. 18 exemplarily illustrates a dimensional drawing of an end plate of each hub of the frame of the floor jack, according to the first embodiment herein.

FIG. 19 indicates exemplary sizes of a tire-wheel assembly of the frame of the floor jack, according to the first embodiment herein.

FIG. 20 is a tabulation of different parts of the frame of the floor jack, according to a second embodiment herein.

FIG. 21 exemplarily illustrates a top view of the frame of the floor jack, according to the second embodiment herein.

FIG. 22 exemplarily illustrates a side view of the frame of the floor jack, according to the second embodiment herein.

FIG. 23 exemplarily illustrates a rear view of the frame of the floor jack, according to the second embodiment herein.

FIG. 24 exemplarily illustrates a perspective view of the frame of the floor jack, according to the second embodiment herein.

FIG. 25 exemplarily illustrates a dimensional drawing of an arched side plate of the frame of the floor jack, according to the second embodiment herein.

FIG. 26 exemplarily illustrates a dimensional drawing of an axle of the frame of the floor jack, according to the second embodiment herein.

FIG. 27 exemplarily illustrates a dimensional drawing of a spreader bar of the frame of the floor jack, according to the second embodiment herein.

FIG. 28 exemplarily illustrates a dimensional drawing of a non-adjustable collar of the frame of the floor jack, according to the second embodiment herein.

FIG. 29 exemplarily illustrates a dimensional drawing of a four-bolt flange bearing of each hub of the frame of the floor jack, according to the second embodiment herein.

FIG. 30 exemplarily illustrates a dimensional drawing of a spacer plate of each hub of the frame of the floor jack, according to the second embodiment herein.

FIG. 31 exemplarily illustrates a dimensional drawing of an end plate of each hub of the frame of the floor jack, according to the second embodiment herein.

FIG. 32 indicates exemplary sizes of a tire-wheel assembly of the frame of the floor jack, according to the second embodiment herein.

FIG. 33 is a tabulation of different parts of the frame of the floor jack, according to a third embodiment herein.

FIG. 34 exemplarily illustrates a top view of the frame of the floor jack, according to the third embodiment herein.

FIG. 35 exemplarily illustrates a side view of the frame of the floor jack, according to the third embodiment herein.

FIG. 36 exemplarily illustrates a rear view of the frame of the floor jack, according to the third embodiment herein.

FIG. 37 exemplarily illustrates a perspective view of the frame of the floor jack, according to the third embodiment herein.

FIG. 38 exemplarily illustrates a dimensional drawing of an arched side plate of the frame of the floor jack, according to the third embodiment herein.

FIG. 39 exemplarily illustrates a dimensional drawing of an axle of the frame of the floor jack, according to the third embodiment herein.

FIG. 40 exemplarily illustrates a dimensional drawing of a spreader bar of the frame of the floor jack, according to the third embodiment herein.

FIG. 41 exemplarily illustrates a dimensional drawing of a non-adjustable collar of the frame of the floor jack, according to the third embodiment herein.

FIG. 42 exemplarily illustrates a dimensional drawing of a four-bolt flange bearing of each hub of the frame of the floor jack, according to the third embodiment herein.

FIG. 43 exemplarily illustrates a dimensional drawing of a spacer plate of each hub of the frame of the floor jack, according to the third embodiment herein.

FIG. 44 exemplarily illustrates a dimensional drawing of an end plate of each hub of the frame of the floor jack, according to the third embodiment herein.

FIG. 45 indicates exemplary sizes of a tire-wheel assembly of the frame of the floor jack, according to the third embodiment herein.

FIG. 46 exemplarily illustrates a perspective view of the frame of the floor jack, according to the first embodiment herein, showing embodiments of the four-bolt flange bearings, the spacer plates, and the axles.

FIG. 47 exemplarily illustrates a top view of the frame of the floor jack shown in FIG. 46.

FIG. 48 exemplarily illustrates an exploded view of the frame of the floor jack shown in FIG. 46.

FIG. 49 exemplarily illustrates a dimensional drawing of an axle of the frame of the floor jack shown in FIG. 46, according to an embodiment herein.

FIG. 50 exemplarily illustrates a dimensional drawing of a thick metal spacer plate of each hub of the frame of the floor jack shown in FIG. 46, according to an embodiment herein.

FIG. 51 exemplarily illustrates a dimensional drawing of a four-bolt flange bearing of each hub of the frame of the floor jack shown in FIG. 46, according to an embodiment herein.

FIG. 52A exemplarily illustrates a perspective view of the frame of the floor jack shown in FIG. 46, illustrating movement of a handle of a lifting mechanism of the floor jack to raise a lifting pad of the lifting mechanism, according to an embodiment herein.

FIG. 52B exemplarily illustrates a perspective view of the frame of the floor jack shown in FIG. 46, illustrating movement of the handle of the lifting mechanism to lower the lifting pad of the lifting mechanism, according to an embodiment herein.

### DETAILED DESCRIPTION

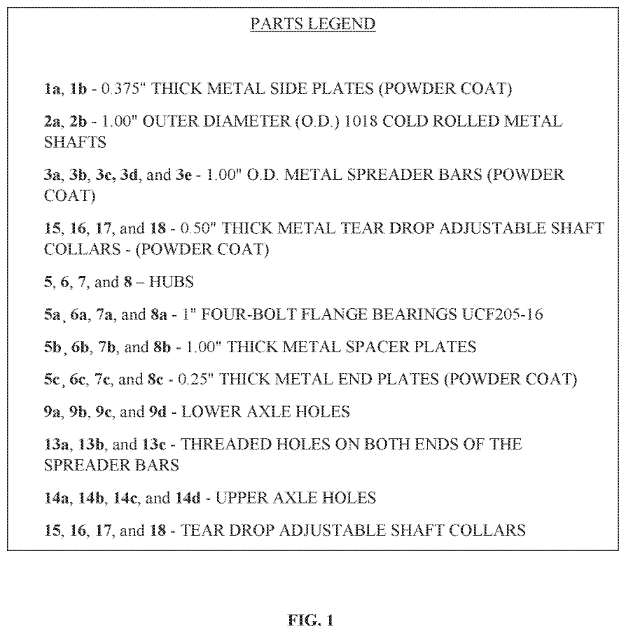

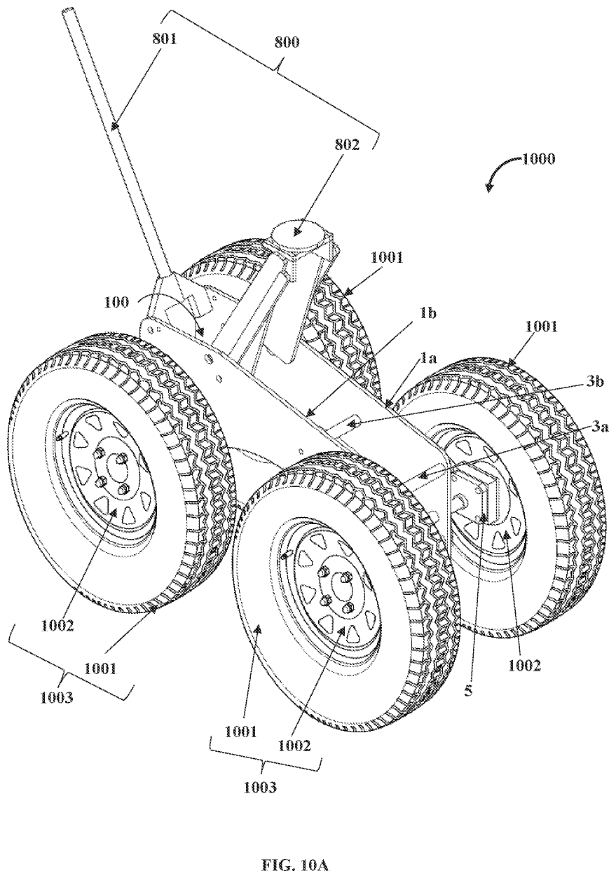

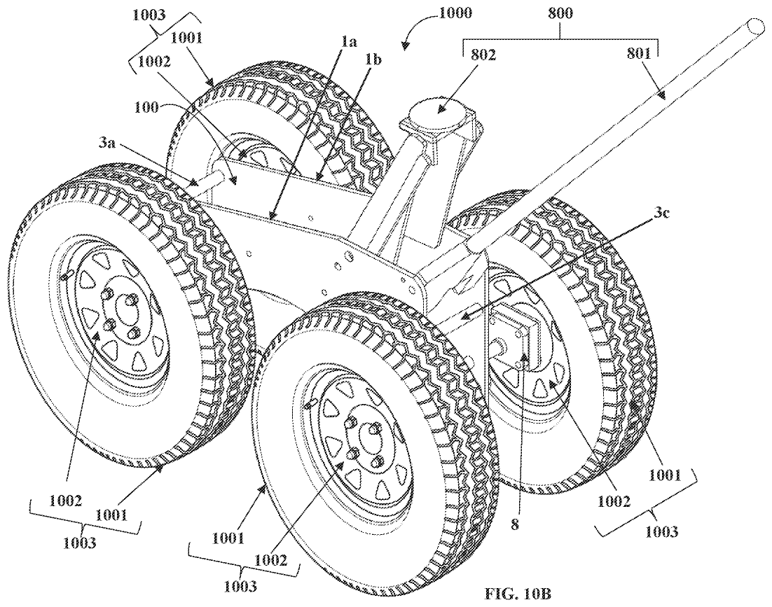

FIGS. 1-19 exemplarily illustrate a first embodiment of a frame 100 of a floor jack 1000 shown in FIGS. 10A-10B and FIG. 11. FIG. 1 is a tabulation of the different parts of the frame 100 for the floor jack 1000 illustrated in FIGS. 10A-10B and FIG. 11, according to the first embodiment herein.

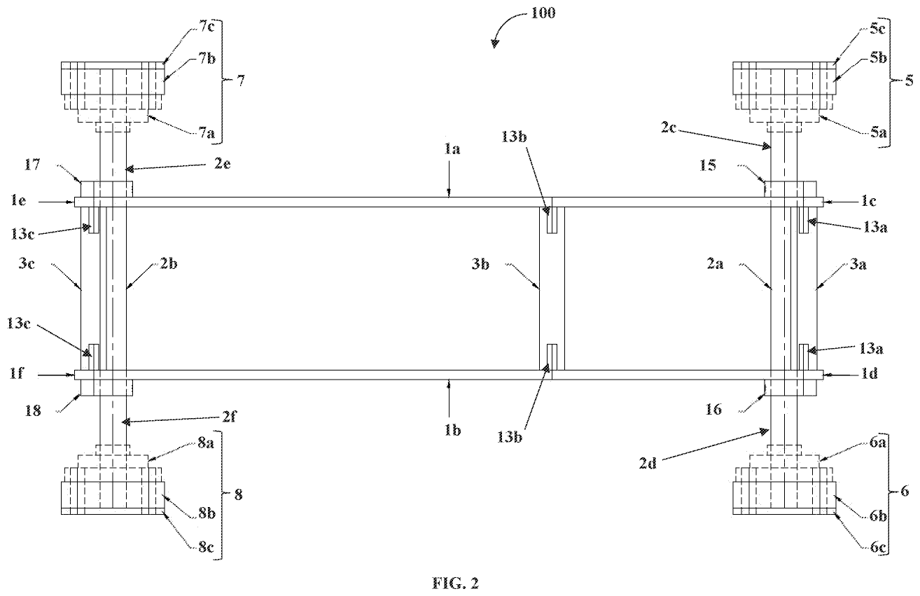

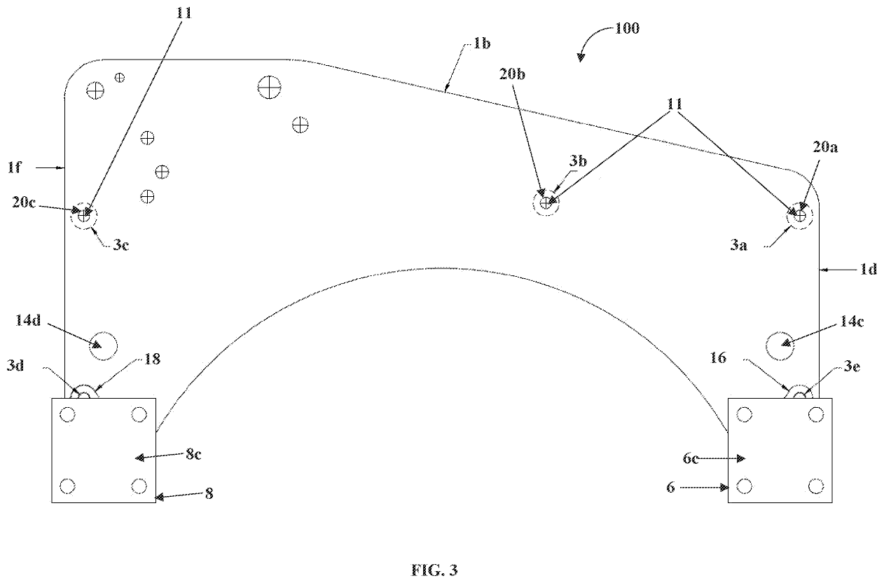

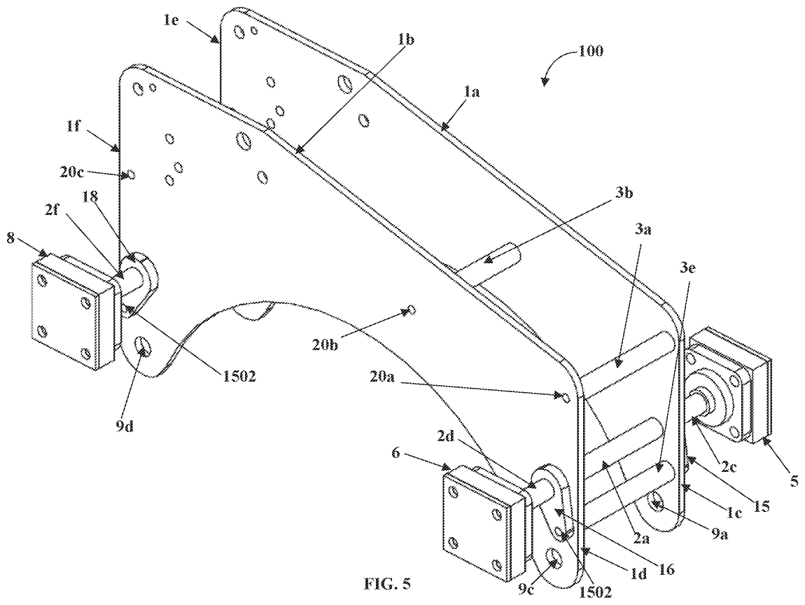

FIG. 2 exemplarily illustrates a top view of the frame 100 of the floor jack 1000 shown in FIGS. 10A-10B and FIG. 11, according to the first embodiment herein. The frame 100 comprises a pair of arched side plates 1a and 1b, a first pair of hubs 5 and 6, a second pair of hubs 7 and 8, a first axle 2a, a second axle 2b, and a set of spreader bars 3a, 3b, 3c, 3d, and 3e as exemplarily illustrated in FIGS. 2-3. The arched side plates 1a and 1b are made of metal and are powder coated. For example, the arched side plates 1a and 1b are powder coated, thick aluminum plates. The thickness of each of the arched side plates 1a and 1b is, for example, about 0.375 inches. The arched side plate 1a comprises a front end 1c and a rear end 1e. The arched side plate 1b comprises a front end 1d and a rear end 1f. The first pair of hubs 5 and 6 is positioned at the front ends 1c and 1d of the pair of arched side plates 1a and 1b respectively. The arched side plates 1a and 1b are connected to the hubs 5 and 6 at the front ends 1c and 1d respectively, via the first axle 2a. The second pair of hubs 7 and 8 is positioned at the rear ends 1e and 1f of the pair of arched side plates 1a and 1b respectively. The arched side plates 1a and 1b are connected to the hubs 7 and 8 at the rear ends 1e and 1f respectively, via the second axle 2b. The first axle 2a connects the pair of arched side plates 1a and 1b to the first pair of hubs 5 and 6 at the front ends 1c and 1d respectively using a first pair of adjustable collars 15 and 16. The second axle 2b connects the pair of arched side plates 1a and 1b to the second pair of hubs 7 and 8 at the rear ends 1e and 1f respectively, using a second pair of adjustable collars 17 and 18. In the first embodiment, the first pair of adjustable collars 15 and 16 and the second pair of adjustable collars 17 and 18 are teardrop-shaped adjustable shaft collars as exemplarily illustrated in FIGS. 5-7. The teardrop-shaped adjustable shaft collars 15, 16, 17, and 18 are connected between the hubs 5, 6, 7, and 8 and the two arched side plates 1a and 1b. The teardrop-shaped adjustable shaft collars 15, 16, 17, and 18 are made of metal, for example, aluminum. The diameter of each of the teardrop-shaped adjustable shaft collars 15, 16, 17, and 18 is, for example, about 0.5 inches. In an embodiment, the teardrop-shaped adjustable shaft collars 15, 16, 17, and 18 are powder coated.

The spreader bars 3a, 3b, 3c, 3d, and 3e separate the pair of arched side plates 1a and 1b along a length of the pair of arched side plates 1a and 1b. The spreader bars 3a, 3b, 3c, 3d, and 3e are made of metal, for example, aluminum. The outer diameter of each of the spreader bars 3a, 3b, 3c, 3d, and 3e is, for example, about 1 inch. In an embodiment, the spreader bars 3a, 3b, 3c, 3d, and 3e are powder coated. In an embodiment, each of the spreader bars 3a, 3b, 3c, 3d, and 3e comprises threaded holes 13a on both its ends as exemplarily illustrated in FIG. 14. FIG. 14 exemplarily illustrates the spreader bar 3a; the structure and the function of each of the spreader bars 3b, 3c, 3d, and 3e are identical to the structure and the characteristics of the spreader bar 3a. The spreader bars 3a, 3b, 3c, 3d, and 3e and the arched side plates 1a and 1b are secured to each other using fasteners 11, for example, threaded screws, threaded bolts, etc., exemplarily illustrated in FIG. 3. As exemplarily illustrated in FIG. 3 and FIGS. 5-7, the arched side plate 1a comprises through holes 19a, 19b, 19c, 19d, and 19e, and the arched side plate 1b comprises through holes 20a, 20b, 20c, 20d, and 20e, for securing the spreader bars 3a, 3b, 3c, 3d, and 3e to the arched side plates 1a and 1b using the fasteners 11. For example, the arched side plate 1a is aligned parallel to the arched side plate 1b such that the through hole 19a in the arched side plate 1a is aligned with the corresponding through hole 20a in the arched side plate 1b. The spreader bar 3a is inserted between the arched side plates 1a and 1b, such that the threaded hole 13a on one end of the spreader bar 3a aligns with the through hole 19a, and the threaded hole 13a on other end of the spreader bar 3a aligns with the through hole 20a. Fasteners, for example, 11, are used to fasten the arched side plates 1a and 1b to the spreader bar 3a by inserting the fasteners 11 into the threaded holes 13a on both ends of the spreader bar 3a via the through holes 19a and 20a. Similarly, the through holes 19b, 19c, and 19d of the arched side plate 1a are aligned with the through holes 20b, 20c, and 20d of the arched side plate 1b respectively, and the opposing ends of the spreader bars 3b, 3c, and 3d are fastened to the arched side plates 1a and 1b by inserting fasteners 11 into their respective threaded holes 13b, 13c, and 13d on both ends of the spreader bars 3b, 3c, and 3d via the through holes 19b, 19c, and 19d and 20b, 20c, and 20d. Furthermore, the through hole 19e of the arched side plate 1a is aligned with the through hole 20e of the arched side plate 1b, and the opposing ends of the spreader bar 3e exemplarily illustrated in FIG. 3, are fastened to the arched side plates 1a and 1b by inserting fasteners 11 into its threaded holes (not shown) on both ends of the spreader bar 3e via the through holes 19e and 20e.

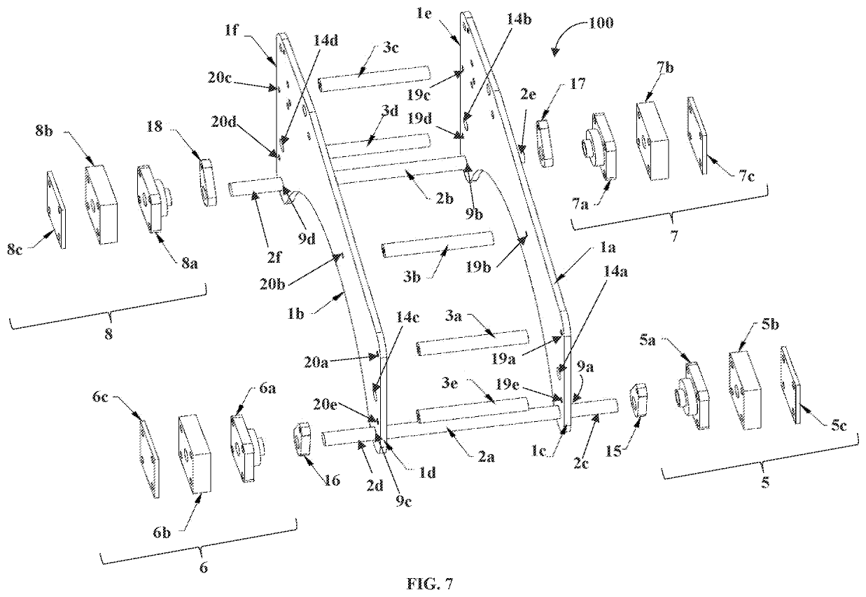

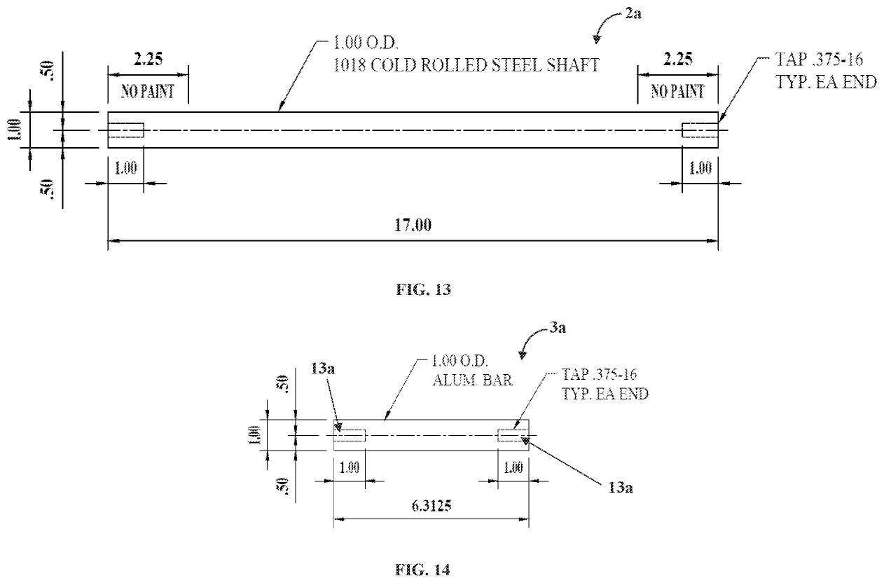

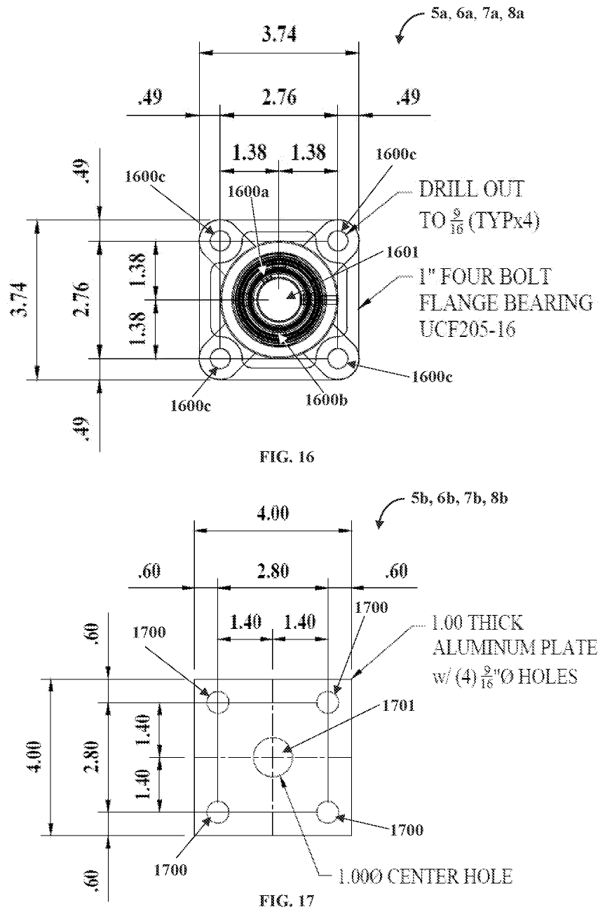

As exemplarily illustrated in FIG. 2, the first axle 2a connects the two arched side plates 1a and 1b to the first pair of hubs 5 and 6 at the front ends 1c and 1d of the arched side plates 1a and 1b, respectively. The second axle 2b connects the two arched side plates 1a and 1b to the second pair of hubs 7 and 8 at the rear ends 1e and 1f of the arched side plates 1a and 1b, respectively. Both the first and second axles 2a and 2b are rotatably engaged with the arched side plates 1a and 1b. The four hubs 5, 6, 7, and 8 are secured to the axles 2a and 2b using set screws 1600a and 1600b exemplarily illustrated in FIG. 16, where each of the set screws 1600a and 1600b is inserted into an individual tapped hole (not shown) in each of four-bolt flange bearings 5a, 6a, 7a, and 8a of the four hubs 5, 6, 7, and 8 respectively as disclosed in the detailed description of FIG. 16. The structure and the function of the second axle 2b is identical to the structure and the function of the first axle 2a exemplarily illustrated in FIG. 13. In an embodiment, the front hub 5 and the front hub 6 are each attached to one of the ends of the first axle 2a. For example, the front hub 5 is attached to an end 2c of the first axle 2a that is adjacent to the first arched side plate 1a, and the front hub 6 is attached to another end 2d of the first axle 2a that is adjacent to the second arched side plate 1b. In an embodiment, the rear hub 7 and the rear hub 8 are each attached to one of the ends of the second axle 2b. For example, the rear hub 7 is attached to an end 2e of the second axle 2b that is adjacent to the first arched side plate 1a, and the rear hub 8 is attached to another end 2f of the second axle 2b that is adjacent to the second arched side plate 1b. In an embodiment, the axles 2a and 2b have an outer diameter of, for example, about 1 inch. In an example, the axles 2a and 2b are configured as 1018 cold rolled metal shafts. In an embodiment, each of the hubs 5, 6, 7, and 8 comprises a set of four parts coaxially positioned on either end of the first axle 2a and the second axle 2b respectively. The four parts of each of the hubs 5, 6, 7, and 8 are a four-bolt flange bearing 5a, 6a, 7a, and 8a, a thick metal spacer plate 5b, 6b, 7b, and 8b, and a thick metal end plate 5c, 6c, 7c, and 8c as exemplarily illustrated in FIG. 7. The diameter of each of the four-bolt flange bearings 5a, 6a, 7a, and 8a is, for example, about 1 inch. An example of the four-bolt flange bearing 5a, 6a, 7a, and 8a is UCF205-16. In an example, the thick metal spacer plates 5b, 6b, 7b, and 8b and the thick metal end plates 5c, 6c, 7c, and 8c are made of aluminum. The diameter of each of the thick metal spacer plates 5b, 6b, 7b, and 8b is, for example, about 1 inch. In an embodiment, each of the thick metal end plates 5c, 6c, 7c, and 8c is powder coated. The diameter of each of the thick metal end plates 5c, 6c, 7c, and 8c is, for example, about 0.25 inches.

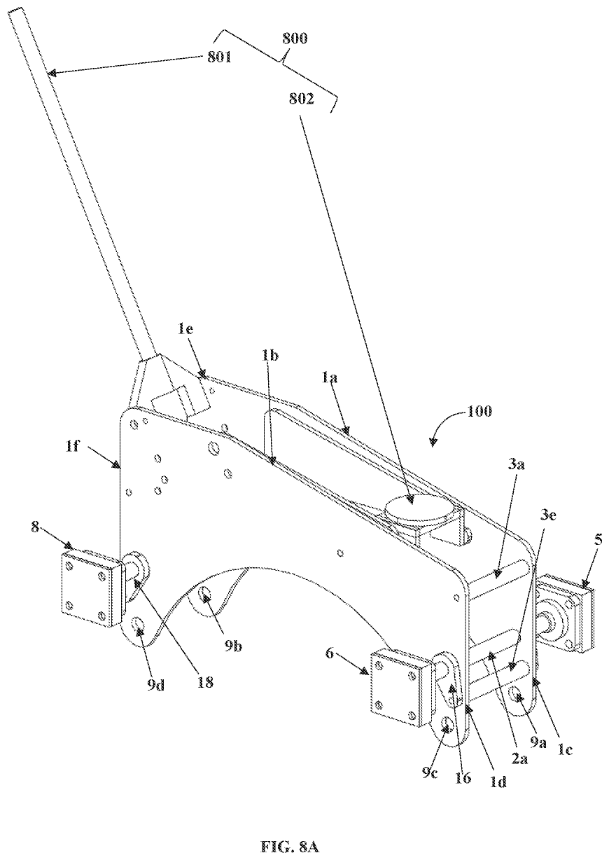

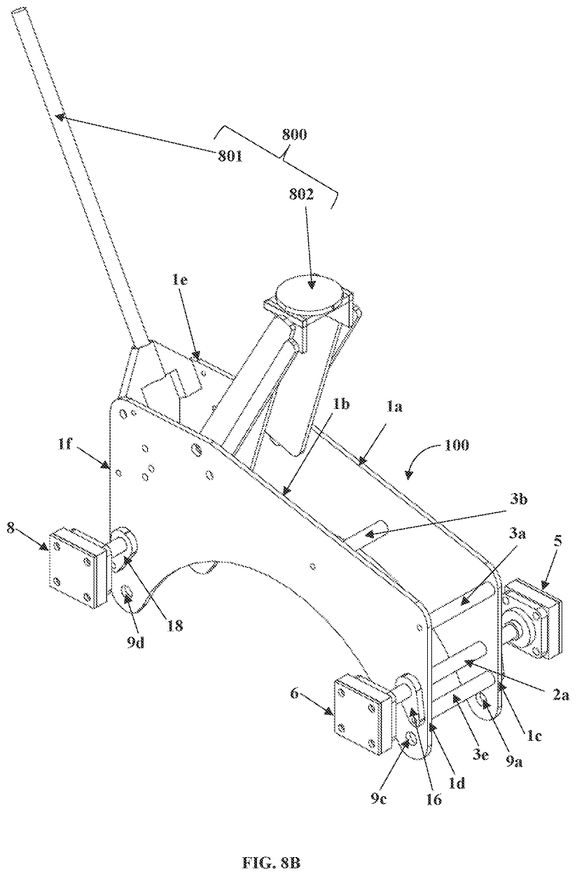

In the first embodiment of the frame 100 as exemplarily illustrated in FIGS. 2-7, FIGS. 8A-8B, and FIGS. 9A-9B, the teardrop-shaped adjustable shaft collars 15, 16, 17, and 18 secure the arched side plates 1a and 1b to the axles 2a and 2b and to the hubs 5, 6, 7, and 8 at the front ends 1c and 1d and the rear ends 1e and 1f of the arched side plates 1a and 1b. The teardrop-shaped adjustable shaft collars 15, 16, 17, and 18 are configured to adjust an elevation of a lifting pad 802 of the floor jack 1000 exemplarily illustrated in FIGS. 8A-10B, above a substantially horizontal surface on which the floor jack 1000 is positioned, between a lowered position and a fully extended position. The elevation of the lifting pad 802, above the substantially horizontal surface on which the floor jack 1000 is positioned, is adjustable between a lowered position and a fully extended position by adjusting the position of the teardrop-shaped adjustable shaft collars 15, 16, 17, and 18. The teardrop-shaped adjustable shaft collars 15, 16, 17, and 18 and appropriate tire-wheel assembly 1003 comprising tires 1001 and wheels 1002 as exemplarily illustrated in FIGS. 10A-10B and FIG. 11, allow the lifting pad 802 to be elevated up to a height of, for example, about 10½ inches, or set to a lower elevation above the substantially horizontal surface on which the floor jack 1000 is positioned. The diameter of a wheel 1002 in each tire-wheel assembly 1003 ranges, for example, from about 3½ inches up to about 25½ inches as indicated in FIG. 19. The lifting pad 802 with about a 3½-inch diameter wheel 1002 is configured to be raised, for example, to about 14¼ inches and about 29¾ inches, above the substantially horizontal surface on which the floor jack 1000 is positioned. In an example, with about a 25½-inch diameter wheel 1002, the minimum elevation to which the lifting pad 802 can be raised, above the substantially horizontal surface on which the floor jack 1000 is positioned, is about 25¼ inches, and the maximum elevation to which the lifting pad 802 can be raised, above the substantially horizontal surface on which the floor jack 1000 is positioned, is about 40¾ inches. In both the configurations, the lifting pad 802 is in a retracted position. Therefore, by using wheels 1002 of various sizes and the teardrop-shaped adjustable shaft collars 15, 16, 17, and 18, the lifting pad 802 can be raised over a range, for example, from about 14¼ inches to about 40¾ inches above the substantially horizontal surface on which the floor jack 1000 is positioned.

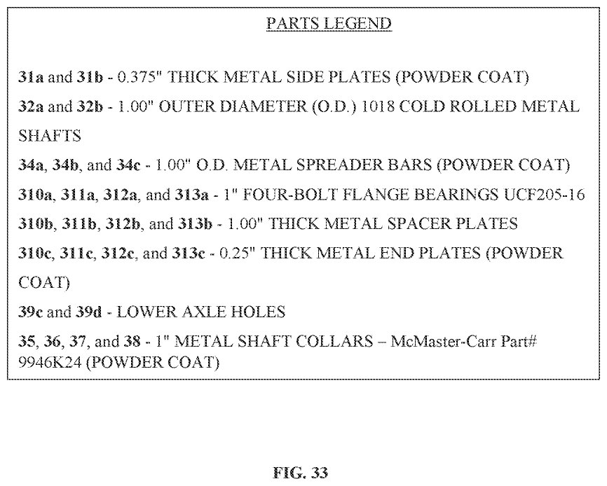

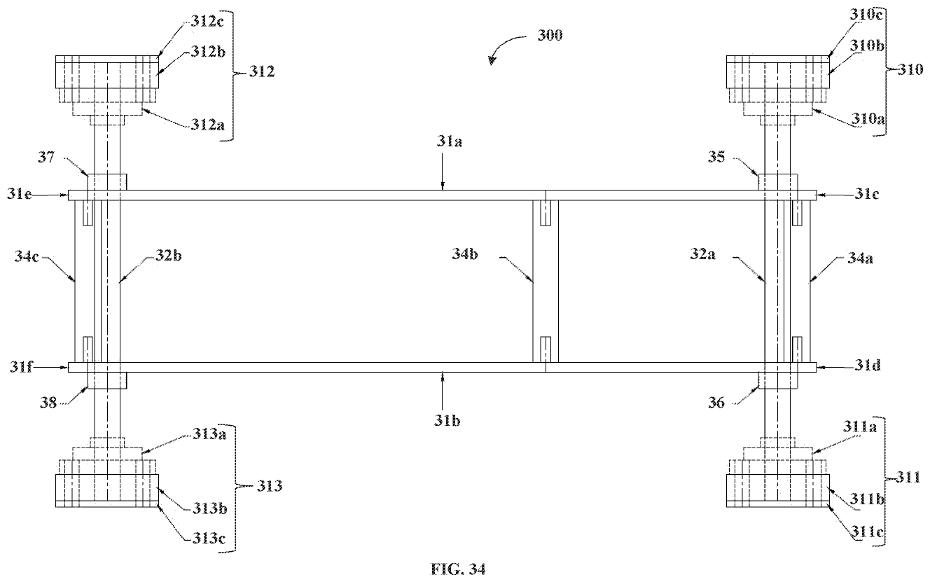

FIG. 3 exemplarily illustrates a side view of the frame 100 of the floor jack 1000 shown in FIGS. 10A-10B and FIG. 11, according to the first embodiment herein. Each of the arched side plates 1a and 1b has an arch structure as exemplarily illustrated by the arched side plate 1b in FIG. 3. Also illustrated in FIG. 3, are the two hubs 6 and 8, one each from the front pair of hubs 5 and 6 and the rear pair of hubs 7 and 8 exemplarily illustrated in FIG. 2. In an example, the length of each of the arched side plates 1a and 1b is about 29 inches. Also illustrated in the side view are upper axle holes 14c and 14d configured on the arched side plate 1b for configuring the floor jack 1000 as a mega jack. The frame 300 configured for a mega jack is disclosed in the detailed descriptions of FIGS. 33-45. The upper axle holes 14a and 14b on the arched side plate 1a are exemplarily illustrated in FIG. 7. Also illustrated in FIG. 3 are the through holes, for example, 20a, 20b, 20c, etc., used for inserting the fasteners 11 and connecting the spreader bars, for example, 3a, 3b, 3c, etc., between the arched side plates 1a and 1b. Also illustrated in FIG. 3 is one of each pair of adjustable collars, for example, 16 and 18, used by the first axle 2a and the second axle 2b for connecting the arched side plates 1a and 1b to their respective hubs 6 and 8. The other of each pair of adjustable collars, for example, 15 and 17, is used by the first axle 2a and the second axle 2b for connecting the arched side plates 1a and 1b to their respective hubs 5 and 7 are exemplarily illustrated in FIG. 2.

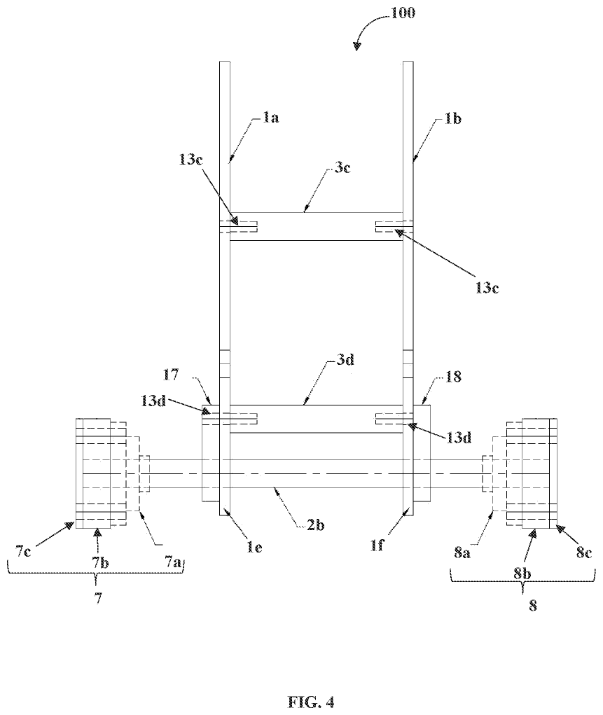

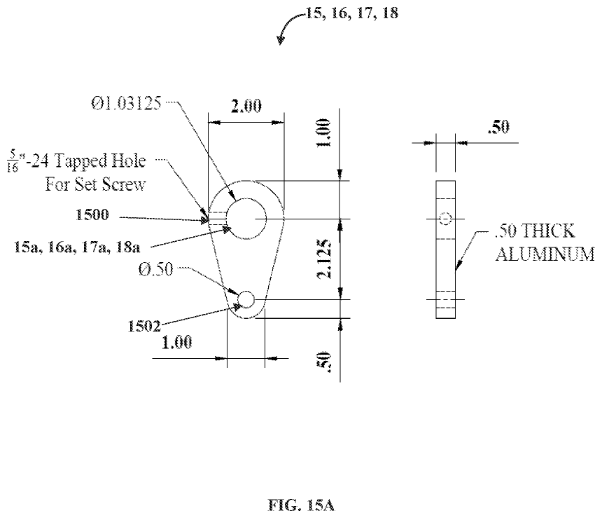

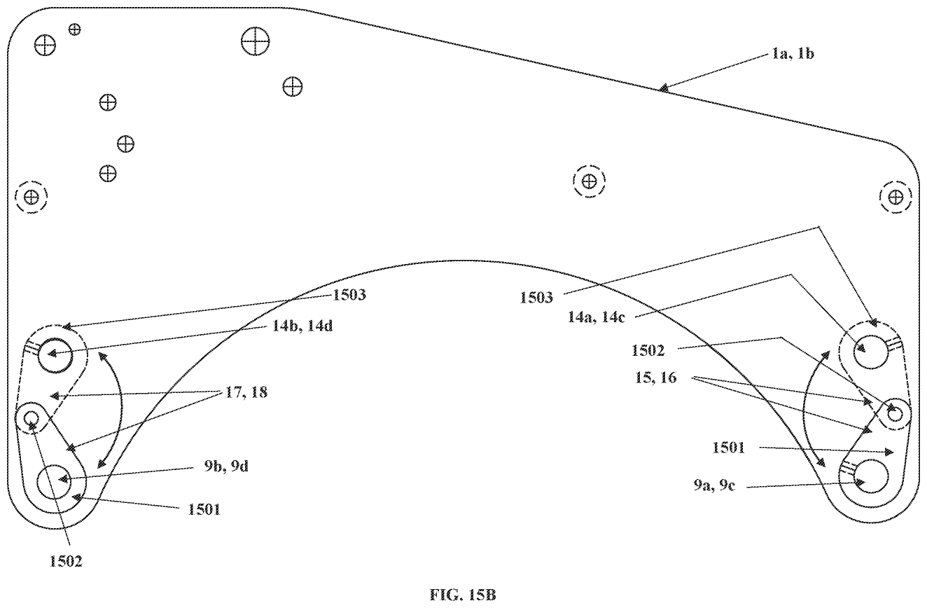

FIG. 4 exemplarily illustrates a rear view of the frame 100 of the floor jack 1000 shown in FIGS. 10A-10B and FIG. 11, according to the first embodiment herein. The rear view illustrates the pair of arched side plates 1a and 1b connected to the hubs 7 and 8 via the second axle 2b at the rear ends 1e and 1f of the two arched side plates 1a and 1b respectively. The arched side plates 1a and 1b are secured to the hubs 7 and 8 using the teardrop-shaped adjustable shaft collars 17 and 18 respectively. Also illustrated in FIG. 4, is the second axle 2b connected to the hubs 7 and 8 at the rear ends 1e and 1f of the arched side plates 1a and 1b respectively. Also illustrated in FIG. 4, are two spreader bars 3c and 3d that separate the two arched side plates 1a and 1b along a width of the arched side plates 1a and 1b. As exemplarily illustrated in FIG. 4, the spreader bar 3c is an upper spreader bar and the spreader bar 3d is a lower spreader bar. The lower spreader bar 3d connects the pivot points 1502 of the two metal, teardrop-shaped adjustable shaft collars 17 and 18 at the rear ends 1e and 1f of the arched side plates 1a and 1b. The pivot point 1502 of each of the metal teardrop-shaped adjustable shaft collars 17 and 18 is exemplarily illustrated in FIG. 5 and FIGS. 15A-15B.

FIG. 5 exemplarily illustrates a perspective view of the frame 100 of the floor jack 1000 shown in FIGS. 10A-10B and FIG. 11, configured in an upper position, according to the first embodiment herein. The assembled frame 100 forms the backbone of the floor jack 1000. The elevation of the frame 100 of the floor jack 1000 is in an upper position when the teardrop-shaped adjustable shaft collars 15, 16, 17, and 18 are in an upper position 1503 as exemplarily illustrated in FIG. 5 and FIG. 15B. The teardrop-shaped adjustable shaft collars 15 and 17 pivot on a plane of the arched side plate 1a about the pivot point 1502 as exemplarily illustrated in FIGS. 5-6 and FIG. 15B. Similarly, the teardrop-shaped adjustable shaft collars 16 and 18 pivot on a plane of the arched side plate 1b about the pivot point 1502 as exemplarily illustrated in FIGS. 5-6 and FIG. 15B. To configure the frame 100 of the floor jack 1000 in the upper position, the teardrop-shaped adjustable shaft collars 15 and 17 are pivoted about the pivot point 1502 to position them in the upper position 1503 as exemplarily illustrated in FIG. 5 and FIG. 15B. The first axle 2a is inserted into a hole 15a of the teardrop-shaped adjustable shaft collar 15 exemplarily illustrated in FIG. 15A, then through the upper axle holes 14a and 14c exemplarily illustrated in FIG. 3 and FIGS. 6-7, and then the first axle 2a exits out of the hole 16a of the teardrop-shaped adjustable shaft collar 16 exemplarily illustrated in FIG. 15A. The first axle 2a rotatably engages with the arched side plates 1a and 1b. The ends 2c and 2d of the first axle 2a extend out through the upper axle holes 14a and 14c respectively as exemplarily illustrated in FIG. 2 and FIGS. 5-7. The teardrop-shaped adjustable shaft collars 16 and 18 are then pivoted about the pivot point 1502 to position them in the upper position 1503 illustrated in FIG. 15B. The second axle 2b is inserted into a hole 17a of the teardrop-shaped adjustable shaft collar 17 exemplarily illustrated in FIG. 15A, then through the upper axle holes 14b and 14d exemplarily illustrated in FIG. 3 and FIGS. 6-7, and then the second axle 2b exits out of the hole 18a of the teardrop-shaped adjustable shaft collar 18 exemplarily illustrated in FIG. 15A. The second axle 2b rotatably engages with the arched side plates 1a and 1b. The ends 2e and 2f of the second axle 2b extend out through the upper axle holes 14b and 14d respectively as exemplarily illustrated in FIG. 2 and FIGS. 6-7. In an embodiment, each of the teardrop-shaped adjustable shaft collars 15, 16, 17 and 18 comprises a tapped hole 1500 exemplarily illustrated in FIG. 15A, for accommodating a set screw (not shown). The set screw is used to secure the teardrop-shaped adjustable shaft collars 15 and 16 against the first axle 2a, and to secure the teardrop-shaped adjustable shaft collars 17 and 18 against the second axle 2b. In an embodiment, securing the teardrop-shaped adjustable shaft collars 15 and 16 against the first axle 2a, and securing the teardrop-shaped adjustable shaft collars 17 and 18 against the second axle 2b prevent the axles 2a and 2b from rotating with respect to the arched side plates 1a and 1b.

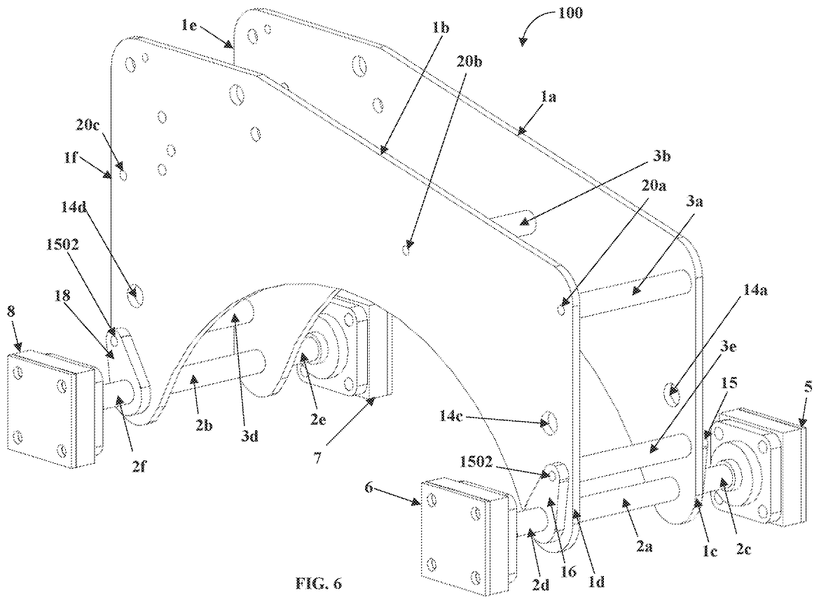

FIG. 6 exemplarily illustrates a perspective view of the frame 100 of the floor jack 1000 shown in FIGS. 10A-10B and FIG. 11, configured in a lower position, according to the first embodiment herein. The elevation of the frame 100 of the floor jack 1000 is configured to be in a lowered position when the teardrop-shaped adjustable shaft collars 15, 16, 17, and 18 are in the lower position 1501 as exemplarily illustrated in FIG. 6 and FIG. 15B. To configure the frame 100 of the floor jack 1000 in a lowered position, the teardrop-shaped adjustable shaft collars 15 and 17 are pivoted about the pivot point 1502 to position them in the lower position 1501 as exemplarily illustrated in FIG. 6 and FIG. 15B. The first axle 2a is inserted into the hole 15a of the teardrop-shaped adjustable shaft collar 15 exemplarily illustrated in FIG. 15A, then through the lower axle holes 9a and 9c exemplarily illustrated in FIG. 5 and FIG. 7, and then the first axle 2a exits out of hole 16a of the teardrop-shaped adjustable shaft collar 16 exemplarily illustrated in FIG. 15A. The first axle 2a rotatably engages with the arched side plates 1a and 1b. The ends 2c and 2d of the first axle 2a extend out through the lower axle holes 9a and 9c respectively as exemplarily illustrated in FIG. 2 and FIGS. 5-7. The teardrop-shaped adjustable shaft collars 16 and 18 are then pivoted about the pivot point 1502 to position them in the lower position 1501. The second axle 2b is inserted into the hole 17a of the teardrop-shaped adjustable shaft collar 17 exemplarily illustrated in FIG. 15A, then through the lower axle holes 9b and 9d, and then the second axle 2b exits out of hole 18a of the teardrop-shaped adjustable shaft collar 18. The second axle 2b rotatably engages with the arched side plates 1a and 1b. The ends 2e and 2f of the second axle 2b extend out through the lower axle holes 9b and 9d respectively as exemplarily illustrated in FIG. 2 and FIGS. 5-7.

FIG. 7 exemplarily illustrates an exploded view of the frame 100 of the floor jack 1000 shown in FIGS. 10A-10B and FIG. 11, according to the first embodiment herein. In this view, the parts of the frame 100 of the floor jack 1000 are disassembled and positioned proximal to each other. Also illustrated in FIG. 7, are the various holes configured in the frame 100, for example, the upper axle holes 14a, 14b, 14c, and 14d used for configuring the frame 100 in the upper position as disclosed in the detailed description of FIG. 5; the lower axle holes 9a, 9b, 9c, and 9d used for configuring the frame 100 in the lower position as disclosed in the detailed description of FIG. 6, and the through holes 19a, 19b, 19c, 19d, 19e and 20a, 20b, 20c, 20d, 20e used for connecting the spreader bars 3a, 3b, 3c, 3d, and 3e between the arched side plates 1a and 1b as disclosed in the detailed description of FIG. 2. Also illustrated in FIG. 7, are the parts of the hubs 5, 6, 7, and 8, namely, the four-bolt flange bearings 5a, 6a, 7a, and 8a, the spacer plates 5b, 6b, 7b, and 8b, and the end plates 5c, 6c, 7c, and 8c.

FIG. 8A exemplarily illustrates a perspective view of the frame 100 of the floor jack 1000 shown in FIGS. 10A-10B and FIG. 11, in the upper position, showing a lifting mechanism 800 of the floor jack 1000, according to the first embodiment herein. The lifting mechanism 800 comprises a handle 801 and a lifting pad 802 positioned between the pair of arched side plates 1a and 1b. In an embodiment, the lifting mechanism 800 is a hydraulic lifting mechanism. The handle 801 is operably connected to the pair of arched side plates 1a and 1b as exemplarily illustrated in FIG. 11, and is configured to raise the lifting pad 802 to an extended position or lower the lifting pad 802 to a lowered position or a retracted position. In FIG. 8A, the elevation of the frame 100 of the floor jack 1000 is shown in the upper position and the lifting pad 802 is shown in a retracted position. The elevation of the lifting pad 802 is adjusted using the handle 801.

FIG. 8B exemplarily illustrates a perspective view of the frame 100 of the floor jack 1000 shown in FIG. 8A, showing the lifting mechanism 800 in an extended position, according to the first embodiment herein. In FIG. 8B, the elevation of the frame 100 of the floor jack 1000 is shown in the upper position, and the lifting pad 802 of the lifting mechanism 800 is shown in the extended position.

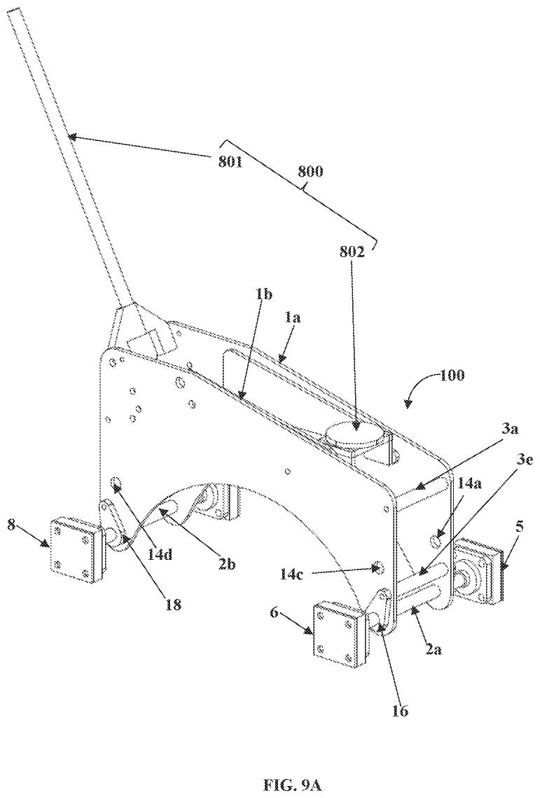

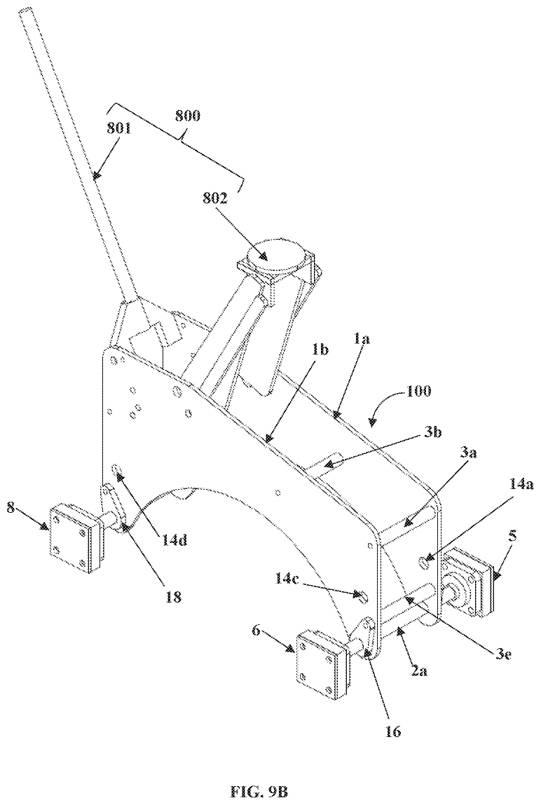

FIG. 9A exemplarily illustrates a perspective view of the frame 100 of the floor jack 1000 shown in FIGS. 10A-10B and FIG. 11, in the lower position, showing the lifting mechanism 800, according to the first embodiment herein. In FIG. 9A, the elevation of the frame 100 of the floor jack 1000 is shown in the lower position and the lifting pad 802 of the lifting mechanism 800 is shown in a lowered position or a retracted position. The handle 801 of the lifting mechanism 800 is used to adjust the elevation of the lifting pad 802 from an extended position to the retracted position exemplarily illustrated in FIG. 9A.

FIG. 9B exemplarily illustrates a perspective view of the frame 100 of the floor jack 1000 shown in FIG. 9A, showing the lifting mechanism 800 in an extended position, according to the first embodiment herein. In FIG. 9B, the elevation of the frame 100 of the floor jack 1000 is shown in the lower position and the lifting pad 802 of the lifting mechanism 800 is shown in an extended position. The handle 801 of the lifting mechanism 800 is used to adjust the elevation of the lifting pad 802 from the retracted position exemplarily illustrated in FIG. 9A, to the extended position exemplarily illustrated in FIG. 9B.

FIG. 10A is a front perspective view of the floor jack 1000 comprising the frame 100, the lifting mechanism 800, and tire-wheel assemblies 1003, according to the first embodiment herein. As exemplarily illustrated in FIG. 10A, the floor jack 1000 comprises a set of four tire-wheel assemblies 1003. The tire-wheel assemblies 1003 are connected to the first pair of hubs 5 and 6 and the second pair of hubs 7 and 8 exemplarily illustrated in FIG. 2 and FIG. 11, to provide mobility to the floor jack 1000 when the floor jack 1000 is assembled. Each of the tire-wheel assemblies 1003 comprises a tire 1001 and a wheel 1002. In FIG. 10A, the lifting pad 802 of the lifting mechanism 800 is shown in an extended position. In an embodiment, the tires 1001 are pneumatic tires that substantially improve the stability of the floor jack 1000 and makes the floor jack 1000 more mobile in rough areas containing, for example, sand, dirt, rocks, mud, etc.

FIG. 10B exemplarily illustrates a rear perspective view of the floor jack 1000 comprising the frame 100, the lifting mechanism 800, and the tire-wheel assemblies 1003, according to the first embodiment herein. Each of the tire-wheel assemblies 1003 comprising a tire 1001 and a wheel 1002 provides mobility to the floor jack 1000 when the floor jack 1000 is assembled. In FIG. 10B, the lifting pad 802 of the lifting mechanism 800 is shown in an extended position.

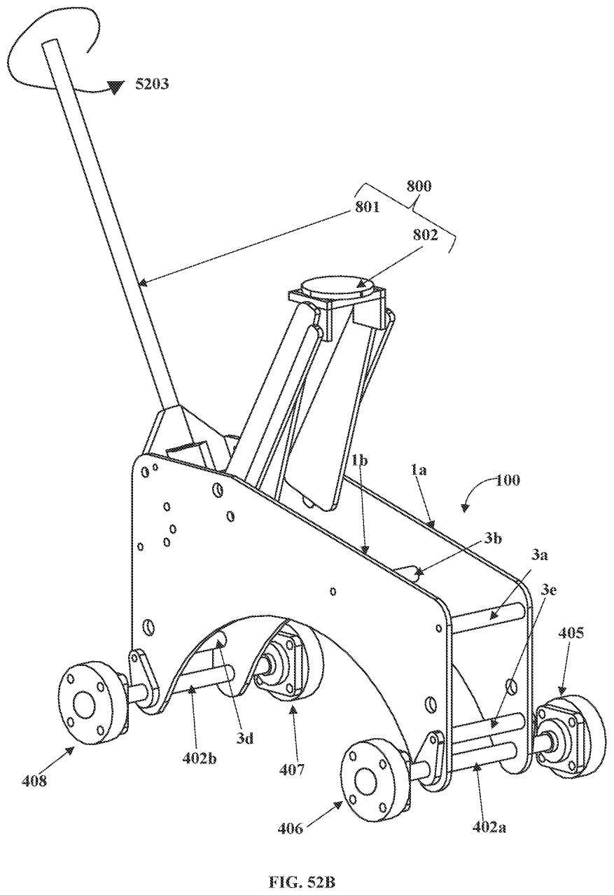

FIG. 11 exemplarily illustrates an exploded view of the floor jack 1000, showing integration of the lifting mechanism 800 in the frame 100 of the floor jack 1000, according to the first embodiment herein. In an embodiment as exemplarily illustrated in FIG. 11, the lifting mechanism 800 is a hydraulic lifting mechanism comprising a pair of lifting arms 807 and 808, a working cylinder 804 with a piston 804a, a pump plunger 805, and a hydraulic fluid reservoir 806. The pump plunger 805 comprises a chamber 805a and a plunger 805b. In an embodiment as exemplarily illustrated in FIG. 11, each of the lifting arms 807 and 808 has a shape resembling a triangle. Each of the lifting arms 807 and 808 comprises an apex corner 807a and 808a respectively. Each of the lifting arms 807 and 808 further comprises a pair of corners 809a and 809b, and 810a and 810b adjacent to base sides 811a and 811b opposite to the apex corners 807a and 808a respectively. The lifting arms 807 and 808 are pivotably connected to the arched side plates 1a and 1b respectively, using fasteners that secure holes 24a and 24b in the arched side plates 1a and 1b with the holes 803a and 803b in the corners 809a and 809b of the lifting arms 807 and 808 respectively. Each of the lifting arms 807 and 808 further comprises a hole (not shown) at the corners 810a and 810b adjacent to the base sides 811a and 811b respectively. A bar 812 is secured between the holes on the corners 810a and 810b of the pair of lifting arms 807 and 808. The piston 804a is rotatably connected to a mid-section of the bar 812. In an embodiment, the hydraulic floor jack 1000 operates using an incompressible liquid, for example, oil, since oil is self-lubricating and stable. The pump plunger 805 forces the liquid into the working cylinder 804 when the handle 801 attached to the plunger 805b is lowered. The plunger 805b is pulled back by turning the handle 801 in a counterclockwise direction 5203 as exemplarily illustrated in FIG. 52B, causing the pump plunger 805 to draw the liquid out of the fluid reservoir 806 through a suction check valve (not shown) into the chamber 805a. When the plunger 805b moves into the chamber 805a of the pump plunger 805, the plunger 805b pushes the oil through a discharge check valve (not shown) into the working cylinder 804. A suction check valve ball (not shown), positioned within the chamber 805a, opens with each draw of the plunger 805b. A discharge check valve ball (not shown), positioned outside the chamber 805a, opens when the liquid is pushed into the working cylinder 804. At this point, the suction check valve ball (not shown) within the chamber 805a is forced shut and liquid pressure builds in the working cylinder 804. The piston 804a slowly advances out of the working cylinder 804 with each stroke of the plunger 805b and pushes the bar 812 at the corners 810a and 810b of the lifting arms 807 and 808 forward. The forward push of the bar 812, in turn, causes the lifting arms 807 and 808 to pivot at the corners 809a and 809b and raise or lift up the lifting pad 802. The lifting pad 802 is lowered by releasing the liquid pressure using a release valve 813. The lifting mechanism 800 allows the elevation of the lifting pad 802 to be adjusted independently from the frame 100 of the floor jack 1000.

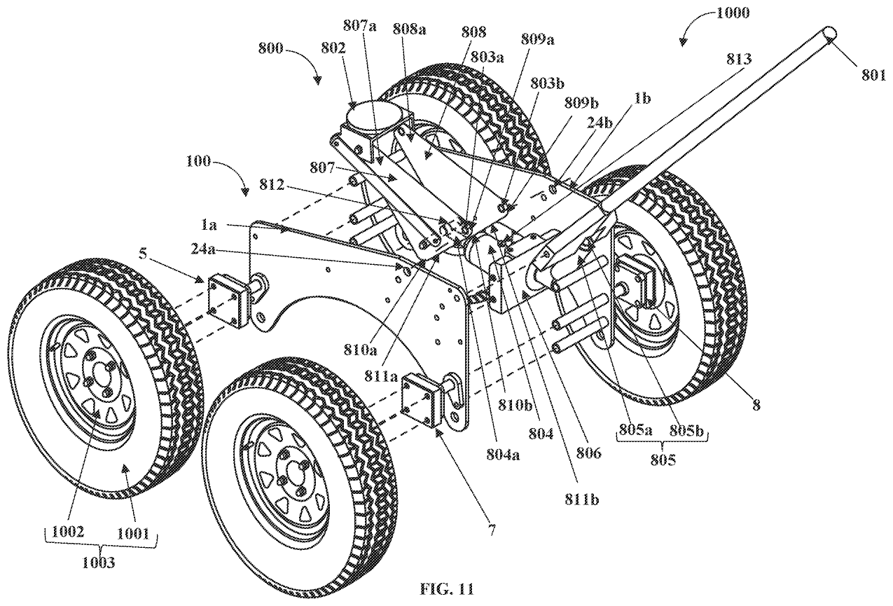

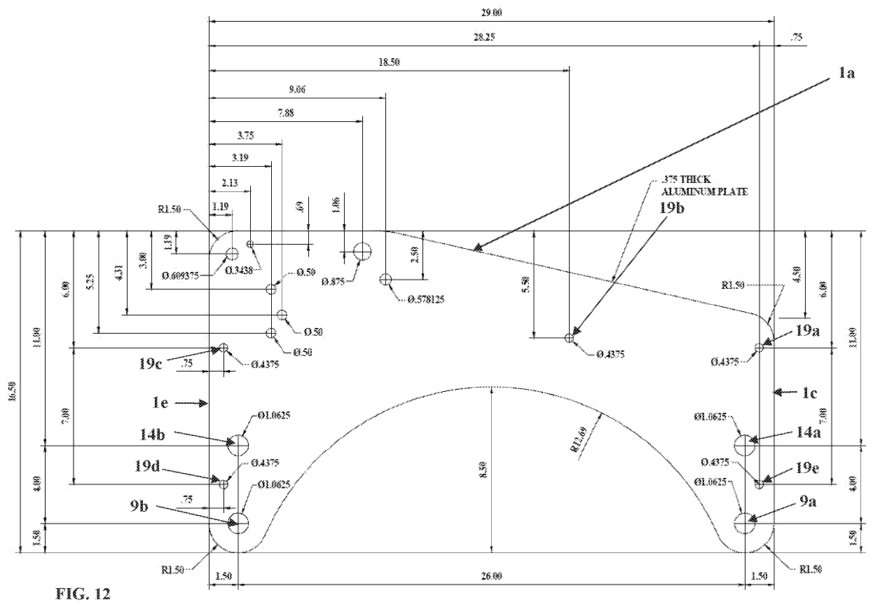

FIG. 12 exemplarily illustrates a dimensional drawing of the arched side plate 1a of the frame 100 of the floor jack 1000 shown in FIGS. 10A-10B and FIG. 11, according to the first embodiment herein. The frame 100 of the floor jack 1000 comprises a pair of arched side plates 1a and 1b. The arched side plate 1b is a replica of the arched side plate 1a exemplarily illustrated in FIG. 12. The arched side plate 1b is illustrated in FIGS. 5-7. Each of the arched side plates 1a and 1b is, for example, about 29 inches long. The width of the arched side plate 1a at the front end 1c is, for example, about 12 inches. The width of the arched side plate 1a at the rear end 1e is, for example, about 16.5 inches. As exemplarily illustrated in FIG. 12, the arched side plate 1a comprises a lower axle hole 9a and an upper axle hole 14a at the front end 1c of the arched side plate 1a, and a lower axle hole 9b and an upper axle hole 14b at the rear end 1e of the arched side plate 1a. The arched side plate 1b comprises a lower axle hole 9c and an upper axle hole 14c at the front end 1d of the arched side plate 1b as exemplarily illustrated in FIGS. 6-7 and FIG. 8A. The arched side plate 1b comprises a lower axle hole 9d and an upper axle hole 14d at the rear end 1f of the arched side plate 1b as exemplarily illustrated in FIGS. 6-7 and FIG. 8A. The elevation of the lifting pad 802 of the floor jack 1000, above a substantially horizontal surface on which the floor jack 1000 is positioned, is adjustable and configured to be set between an upper position 1503 and a lower position 1501 as exemplarily illustrated in FIG. 15B, by adjusting the position of the teardrop-shaped adjustable shaft collars 15, 16, 17, and 18 to the upper position 1503 or the lower position 1501, with the teardrop-shaped adjustable shaft collars 15, 16, 17, and 18 coinciding with the upper axle holes 14a, 14c, 14b, and 14d exemplarily illustrated in FIGS. 6-7 and FIG. 15B, or the lower axle holes 9a, 9c, 9b, and 9d exemplarily illustrated in FIG. 5, FIG. 7, and FIG. 8A respectively. The upper axle holes 14a, 14b, 14c, and 14d are used for configuring the floor jack 1000 as a mega floor jack. The frame 300 for the mega floor jack is disclosed in the detailed descriptions of FIGS. 33-45. The lower axle holes 9a, 9b, 9c, and 9d are used for configuring the frame 100 of the floor jack 1000 with the elevation of the lifting pad 802 as disclosed in the detailed description of FIG. 6 and FIGS. 9A-9B. In an example, the diameter of each of the upper axle holes 14a, 14b, 14c, and 14d and each of the lower axle holes 9a, 9b, 9c, and 9d is about 1.0625 inches. FIG. 12 also exemplarily illustrates the through holes 19a, 19b, 19c, 19d, and 19e of the arched side plate 1a used for securing the spreader bars 3a, 3b, 3c, 3d, and 3e exemplarily illustrated in FIG. 7, to the arched side plate 1a using the fasteners 11 exemplarily illustrated in FIG. 3. The arched side plate 1b comprises the through holes 20a, 20b, 20c, 20d, and 20e used for securing the spreader bars 3a, 3b, 3c, 3d, and 3e to the arched side plate 1b using the fasteners 11 as exemplarily illustrated in FIG. 3. In an example, the diameter of each of the through holes 19a, 19b, 19c, 19d, and 19e of the arched side plate 1a and each of the through holes 20a, 20b, 20c, 20d, and 20e of the arched side plate 1b is about 0.4375 inches. Exemplary dimensions of the spacings between various holes configured in the arched side plate 1a and other exemplary dimensions are illustrated in FIG. 12.

FIG. 13 exemplarily illustrates a dimensional drawing of an axle, that is, the first axle 2a, of the frame 100 of the floor jack 1000 shown in FIGS. 10A-10B and FIG. 11, according to the first embodiment herein. The frame 100 of the floor jack 1000 comprises two axles, that is, the first axle 2a and the second axle 2b as exemplarily illustrated in FIG. 2. The first axle 2a is located proximal to the front ends 1c and 1d of the arched side plates 1a and 1b, and the second axle 2b is located proximal to the rear ends 1e and 1f of the arched side plates 1a and 1b. In an embodiment, each of the axles 2a and 2b is a cold rolled metal shaft. For example, each of the axles 2a and 2b is a cold rolled steel shaft. Each of the axles 2a and 2b is, for example, about 17 inches long, having a diameter of about 1 inch. In another embodiment, the length of each of the axles 22a and 22b is, for example, about 15.75 inches. Other exemplary dimensions of the first axle 2a, and in turn, the second axle 2b are illustrated in FIG. 13. As exemplarily illustrated in FIG. 7, the two axles 2a and 2b are located proximal to a lower section of the frame 100. The two axles 2a and 2b are aligned parallel to each other when the elevation of the frame 100 of the floor jack 1000 is configured to be in either the upper position or in the lower position as exemplarily illustrated in FIGS. 5-6.

FIG. 14 exemplarily illustrates a dimensional drawing of a spreader bar 3a of the frame 100 of the floor jack 1000 shown in FIGS. 10A-10B and FIG. 11, according to the first embodiment herein. The spreader bar 3a is configured to separate the two arched side plates 1a and 1b along the length of the arched side plates 1a and 1b as exemplarily illustrated in FIG. 2, wherein the length of the arched side plates 1a and 1b is, for example, about 29 inches. In an embodiment, the frame 100 of the floor jack 1000 comprises about five spreader bars 3a, 3b, 3c, 3d, and 3e as exemplarily illustrated in FIG. 7. In an embodiment, the spreader bars 3a, 3b, 3c, 3d, and 3e are configured as metal bars, for example, aluminum bars. In an example, each of the spreader bars 3a, 3b, 3c, 3d, and 3e is about 6.3125 inches long, having an outer diameter of about 1 inch. Other exemplary dimensions of the spreader bar 3a, and in turn, each of the other spreader bars 3b, 3c, 3d, and 3e are illustrated in FIG. 14. Two of the spreader bars 3a and 3e are located proximal to the front ends 1c and 1d of the arched side plates 1a and 1b, where the spreader bar 3a is positioned above the spreader bar 3e as exemplarily illustrated in FIG. 7. Another two of the spreader bars 3c and 3d are located proximal to the rear ends 1e and 1f of the arched side plates 1a and 1b, where the spreader bar 3c is positioned above the spreader bar 3d as exemplarily illustrated in FIG. 7. The spreader bar 3b is located between a mid-section of the frame 100 and the front ends 1c and 1d of the arched side plates 1a and 1b as exemplarily illustrated in FIGS. 5-6. The positions and the number of the spreader bars 3a, 3b, 3c, 3d, and 3e are a design choice. In an embodiment, the spreader bars 3a, 3b, 3c, 3d, and 3e are positioned anywhere between the arched side plates 1a and 1b based on the design of the lifting mechanism 800 exemplarily illustrated in FIGS. 8A-8B and FIGS. 9A-9B.

FIG. 15A exemplarily illustrates a dimensional drawing of an adjustable collar, for example, a teardrop-shaped adjustable shaft collar 15, 16, 17, 18 of the frame 100 of the floor jack 1000 shown in FIGS. 10A-10B and FIG. 11, according to the first embodiment herein. The teardrop-shaped adjustable shaft collars 15, 16, 17, and 18 secure the arched side plates 1a and 1b of the frame 100 to the axles 2a and 2b and to the hubs 5, 6, 7 and 8 as exemplarily illustrated in FIG. 2 and FIG. 7. In an example, the thickness of each of the teardrop-shaped adjustable shaft collars 15, 16, 17, and 18 is about 0.5 inches. Each of the teardrop-shaped adjustable shaft collars 15, 16, 17, and 18 is, for example, made of aluminum.

The teardrop-shaped adjustable shaft collars 15, 16, 17, and 18 comprise holes 15a, 16a, 17a, and 18a respectively, through which the first axle 2a and the second axle 2b are inserted for connection to the hubs 5, 6, 7, and 8 as exemplarily illustrated in FIG. 7. That is, the ends 2c and 2d of the first axle 2a are inserted through the holes 15a and 16a of the teardrop-shaped adjustable shaft collars 15 and 16 respectively, for connecting the arched side plates 1a and 1b to the first pair of hubs 5 and 6 respectively as exemplarily illustrated in FIG. 7. Similarly, the ends 2e and 2f of the second axle 2b are inserted through the holes 17a and 18a of the teardrop-shaped adjustable shaft collars 17 and 18 respectively, for connecting the arched side plates 1a and 1b to the second pair of hubs 7 and 8 respectively as exemplarily illustrated in FIG. 7. In an example, the diameter of each of the holes 15a, 16a, 17a, and 18a of the teardrop-shaped adjustable shaft collars 15, 16, 17, and 18 respectively, is about 1.03125 inches. Furthermore, each of the teardrop-shaped adjustable shaft collars 15, 16, 17, and 18 comprises a pivot point 1502 about which each of the teardrop-shaped adjustable shaft collars 15, 16, 17, and 18 pivot to adjust the elevation of the floor jack 1000. In an example, the diameter of the pivot point is about 0.5 inches. In an embodiment, each of the teardrop-shaped adjustable shaft collars 15, 16, 17 and 18 further comprises a tapped hole 1500 for accommodating a set screw (not shown) used for securing the teardrop-shaped adjustable shaft collars 15 and 16 against the first axle 2a, and to secure the teardrop-shaped adjustable shaft collars 17 and 18 against the second axle 2b as disclosed in the detailed description of FIG. 5. The tapped hole 1500 is, for example, a 5/16-inch tapped hole. Other exemplary dimensions of each of the teardrop-shaped adjustable shaft collars 15, 16, 17, and 18 are illustrated in FIG. 15A.

FIG. 15B exemplarily illustrates positional settings of each of the adjustable collars, for example, the teardrop-shaped adjustable shaft collars 15, 16, 17, and 18 of the frame 100 of the floor jack 1000 shown in FIGS. 10A-10B and FIG. 11, according to the first embodiment herein. The upper axle holes 14a, 14b, 14c, and 14d and the lower axle holes 9a, 9b, 9c, and 9d of the arched side plates 1a and 1b corresponding to the upper position 1503 and the lower position 1501 of the teardrop-shaped adjustable shaft collars 15, 16, 17, and 18 respectively, allow adjustment of the elevation of the lifting pad 802 of the floor jack 1000 exemplarily illustrated in FIGS. 8A-8B and FIGS. 9A-9B. As exemplarily illustrated in FIG. 15B, the teardrop-shaped adjustable shaft collars 15, 16, 17, and 18 pivot on a plane of the arched side plates 1a and 1b about their pivot points 1502 to switch between a lower position 1501 and an upper position 1503 to adjust the elevation of the lifting pad 802 of the floor jack 1000.

FIG. 16 exemplarily illustrates a dimensional drawing of a four-bolt flange bearing 5a, 6a, 7a, 8a of each hub 5, 6, 7, 8 of the frame 100 of the floor jack 1000 shown in FIG. 7, FIGS. 10A-10B, and FIG. 11. The four-bolt flange bearings 5a, 6a, 7a, and 8a are part of their respective hubs 5, 6, 7, and 8 as exemplarily illustrated in FIG. 2 and FIG. 7. In an embodiment, each of the four-bolt flange bearings 5a, 6a, 7a, and 8a is square-shaped with each side measuring, for example, about 3.74 inches. The four hubs 5, 6, 7, and 8 are secured to the axles 2a and 2b using one or more set screws 1600a and 1600b, each inserted into an individual tapped hole (not shown) in each of the four-bolt flange bearings 5a, 6a, 7a, and 8a of the four hubs 5, 6, 7, and 8 respectively. Each of the four-bolt flange bearings 5a, 6a, 7a, and 8a further comprises drill holes 1600c drilled out, for example, to about 9/16 inches, for securing the four-bolt flange bearings 5a, 6a, 7a, and 8a to the respective spacer plates 5b, 6b, 7b, and 8b and end plates 5c, 6c, 7c, and 8c of their respective hubs 5, 6, 7, and 8 using fasteners (not shown) as exemplarily illustrated in FIG. 7. The four-bolt flange bearings 5a, 6a, 7a, and 8a further comprise center holes 1601 coaxial to the holes 15a, 16a, 17a, and 18a of the teardrop-shaped adjustable shaft collars 15, 16, 17, and 18 respectively, exemplarily illustrated in FIG. 15A. The center holes 1601 of the four-bolt flange bearings 5a, 6a, 7a, and 8a allow connection of the ends 2c, 2d, and 2e, 2f of the axles 2a and 2b respectively, to the respective hubs 5, 6, 7, and 8 as exemplarily illustrated in FIG. 7. Other exemplary dimensions of each of the four-bolt flange bearings 5a, 6a, 7a, and 8a are illustrated in FIG. 16.

FIG. 17 exemplarily illustrates a dimensional drawing of a spacer plate 5b, 6b, 7b, 8b of each hub 5, 6, 7, 8 of the frame 100 of the floor jack 1000 shown in FIG. 7, FIGS. 10A-10B, and FIG. 11, according to the first embodiment herein. The spacer plates 5b, 6b, 7b, and 8b are part of their respective hubs 5, 6, 7, and 8 as exemplarily illustrated in FIG. 2 and FIG. 7. The spacer plates 5b, 6b, 7b, and 8b are thick metal spacer plates, for example, made of aluminum. In an embodiment, each of the thick metal spacer plates 5b, 6b, 7b, and 8b is square-shaped, with each side measuring, for example, about 4 inches in width and about 1.25 inches in thickness. Each of the thick metal spacer plates 5b, 6b, 7b, and 8b comprises four holes 1700 corresponding to the holes 1600c of each of the four-bolt flange bearings 5a, 6a, 7a, and 8a. In an example, the diameter of each of the holes 1700 is 9/16 inches. A thick metal spacer plate, for example, 5b, of the hub 5 is secured to the four-bolt flange bearing 5a of the hub 5 by using nuts and bolts inserted into the four holes 1700 of the thick metal spacer plate 5b and the corresponding four holes 1600c of the four-bolt flange bearing 5a. Similarly, the thick metal spacer plates 6b, 7b, and 8b of the hubs 6, 7, and 8 respectively, are secured to the respective four-bolt flange bearings 6a, 7a, and 8a of their respective hubs 6, 7, and 8 by using nuts and bolts inserted into the four holes 1700 of the thick metal spacer plates 6b, 7b, and 8b and the corresponding four holes 1600c of the four-bolt flange bearings 6a, 7a, and 8a. The spacer plates 5b, 6b, 7b, and 8b further comprise center holes 1701 coaxial to the holes 15a, 16a, 17a, and 18a of the teardrop-shaped adjustable shaft collars 15, 16, 17, and 18 respectively, exemplarily illustrated in FIG. 15A, and to the center holes 1601 of the four-bolt flange bearings 5a, 6a, 7a, and 8a respectively, exemplarily illustrated in FIG. 16. The center holes 1701 of the spacer plates 5b, 6b, 7b, and 8b allow connection of the ends 2c, 2d, and 2e, 2f of the axles 2a and 2b respectively, to the respective hubs 5, 6, 7, and 8 as exemplarily illustrated in FIG. 7. In an example, the diameter of the center hole 1701 of each of the spacer plates 5b, 6b, 7b, and 8b is about 1 inch. Other exemplary dimensions of each of the spacer plates 5b, 6b, 7b, and 8b are illustrated in FIG. 17.

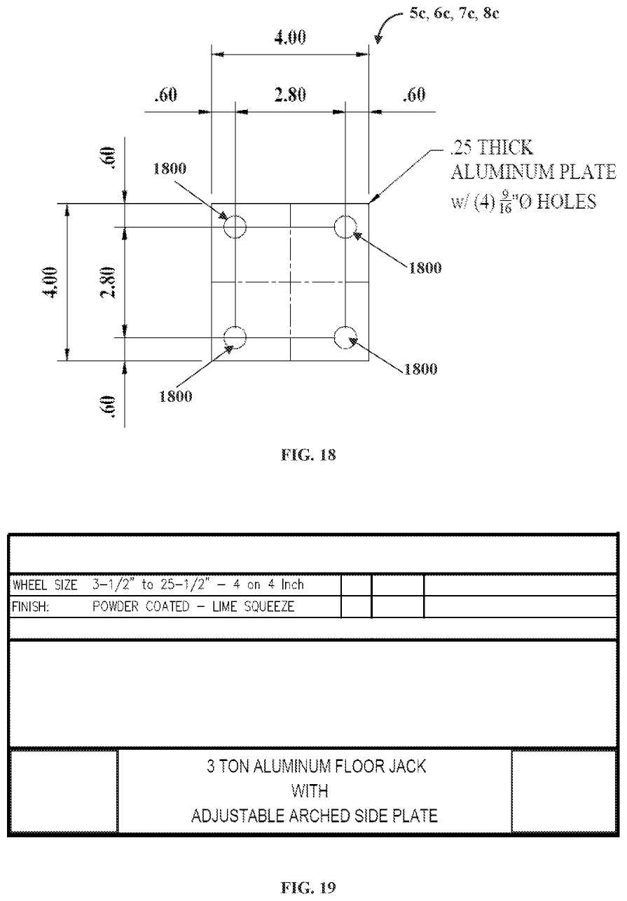

FIG. 18 exemplarily illustrates a dimensional drawing of an end plate 5c, 6c, 7c, 8c of each hub 5, 6, 7, 8 of the frame 100 of the floor jack 1000 shown in FIG. 7, FIGS. 10A-10B, and FIG. 11, according to the first embodiment herein. The end plates 5c, 6c, 7c, and 8c are part of their respective hubs 5, 6, 7, and 8 as exemplarily illustrated in FIG. 2 and FIG. 7. The end plates 5c, 6c, 7c, and 8c are thick metal end plates, for example, made of aluminum. In an embodiment, each of the thick metal end plates 5c, 6c, 7c, and 8c is square-shaped with each side measuring, for example, about 4 inches. Furthermore, each of the thick metal end plates 5c, 6c, 7c, and 8c is, for example, about 0.25 inches thick and comprises holes 1800, each with a diameter of, for example, about 9/16 inches. The holes 1800 of each of the thick metal end plates 5c, 6c, 7c, and 8c are coaxial to the holes 1600c of the respective four-bolt flange bearings 5a, 6a, 7a, and 8a exemplarily illustrated in FIG. 16 and to the holes 1700 of the respective spacer plates 5b, 6b, 7b, and 8b exemplarily illustrated in FIG. 17. The hubs 5, 6, 7, and 8 exemplarily illustrated in FIGS. 6-7 are formed by inserting fasteners (not shown), for example, bolts, through the holes 1600c of each of the four-bolt flange bearings 5a, 6a, 7a, and 8a, the holes 1700 of the respective spacer plates 5b, 6b, 7b, and 8b, and the holes 1800 of the respective thick metal end plates 5c, 6c, 7c, and 8c. The axles 2a and 2b connect the arched side plates 1a and 1b to the hubs 5, 6, 7, and 8 as exemplarily illustrated in FIGS. 6-7 and as disclosed in the detailed descriptions of FIG. 15A and FIGS. 16-17. Other exemplary dimensions of each of the thick metal end plates 5c, 6c, 7c, and 8c are illustrated in FIG. 18.

FIG. 19 indicates exemplary sizes of a tire-wheel assembly 1003 of the frame 100 of the floor jack 1000 shown in FIGS. 10A-10B and FIG. 11, according to the first embodiment herein. The tire-wheel assembly 1003 comprises a tire 1001 and a wheel/rim 1002 as exemplarily illustrated in FIGS. 10A-10B and FIG. 11. In an example, the width of the tire 1001 is about 4 inches and aspect ratio of the tire 1001 is about 4 inches. In an example, the tire-wheel assembly 1003 has a lime squeeze powder coating finish. The frame 100 of the floor jack 1000 of the first embodiment is used with a tire 1001 and wheel/rim 1002 combination in a range of, for example, about 3½-inch diameters up to 25½-inch diameters. The minimum height of the lifting pad 802 exemplarily illustrated in FIGS. 10A-10B and FIG. 11, above a substantially horizontal surface on which the floor jack 1000 is positioned, with a 3½-inch diameter wheel/rim 1002 is, for example, about 14¼ inches, and the maximum height of the lifting pad 802 above the substantially horizontal surface on which the floor jack 1000 is positioned is, for example, about 29¾ inches. With a 25½-inch diameter wheel/rim 1002, the minimum height of the lifting pad 802 above the substantially horizontal surface on which the floor jack 1000 is positioned is, for example, about 25¼ inches, and the maximum height of the lifting pad 802 above the substantially horizontal surface on which the floor jack 1000 is positioned is, for example, about 40¾ inches.

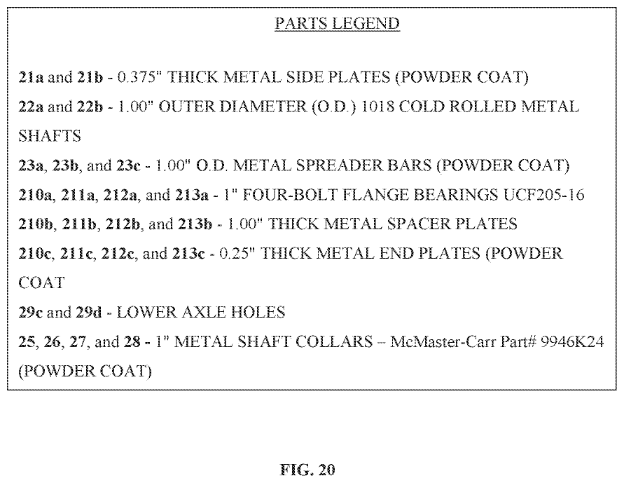

FIGS. 20-32 exemplarily illustrate a second embodiment of a frame 200 for a floor jack 1000 shown in FIGS. 10A-10B and FIG. 11. In the second embodiment, the frame 200 is configured for a fixed height floor jack. In the second embodiment, the frame 200 comprises non-adjustable shaft collars 25, 26, 27, and 28 in lieu of the teardrop-shaped adjustable shaft collars 15, 16, 17, and 18 of the frame 100 exemplarily illustrated in FIG. 2 and FIG. 7. The set of parts in the second embodiment of the frame 200 is the same as the parts of the first embodiment of the frame 100 except that the teardrop-shaped adjustable shaft collars 15, 16, 17, and 18 of the frame 100 are replaced with fixed or non-adjustable shaft collars 25, 26, 27, and 28 in the frame 200. FIG. 20 is a tabulation of different parts of the frame 200 of the floor jack 1000, according to the second embodiment herein.

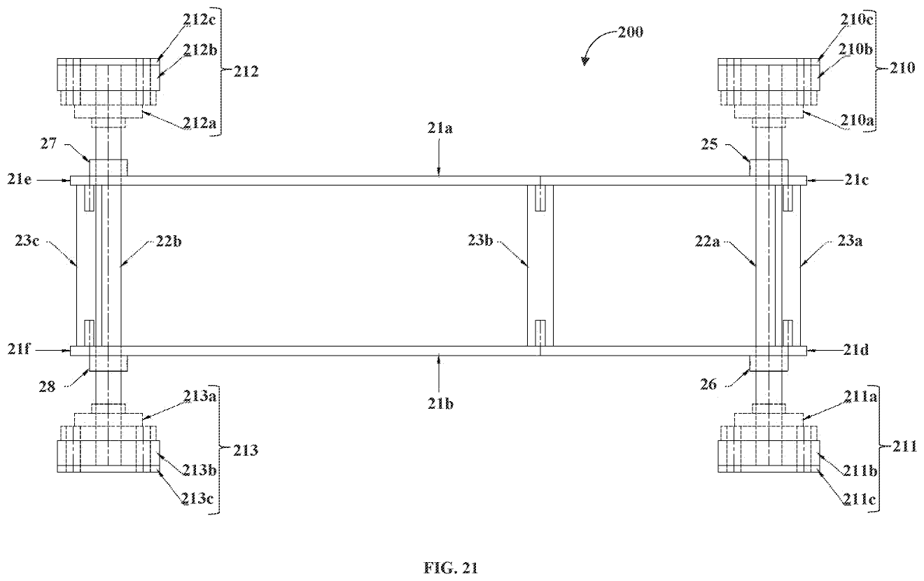

FIG. 21 exemplarily illustrates a top view of the frame 200 of the floor jack 1000 shown in FIGS. 10A-10B and FIG. 11, according to the second embodiment herein. The frame 200 comprises the following parts: a pair of arched side plates 21a and 21b, a first pair of hubs 210 and 211, a second pair of hubs 212 and 213, a first axle 22a, a second axle 22b, non-adjustable shaft collars 25, 26, 27, and 28, and a set of spreader bars 23a, 23b, and 23c as exemplarily illustrated in FIGS. 21-24. In an embodiment, the pair of arched side plates 21a and 21b is made of thick metal and is powder coated. The structure and function of the parts of the frame 200 of the second embodiment are similar to the structure and function of the corresponding parts of the frame 100 of the first embodiment as disclosed in the detailed description of FIG. 2.

The first axle 22a connects the pair of arched side plates 21a and 21b to the first pair of hubs 210 and 211 at the front ends 21c and 21d respectively, using a first pair of non-adjustable collars 25 and 26. The second axle 22b connects the pair of arched side plates 21a and 21b to the second pair of hubs 212 and 213 at the rear ends 21e and 21f respectively, using a second pair of non-adjustable collars 27 and 28. In an embodiment, the first pair of non-adjustable collars 25 and 26 and the second pair of non-adjustable collars 27 and 28 are fixed metal shaft collars, for example, made of aluminum. The aluminum or other metal, non-adjustable shaft collars 25, 26, 27, and 28 of the frame 200 are used to secure the arched side plates 21a and 21b to the axles 22a and 22b, and to the hubs 210, 211, 212, and 213 at the front ends 21c and 21d and the rear ends 21e and 21f of the arched side plates 21a and 21b. In an example, each of the non-adjustable shaft collars 25, 26, 27, and 28 is about 1 inch in diameter. In an embodiment, each of the non-adjustable shaft collars 25, 26, 27, and 28 is powder coated. An example of the non-adjustable shaft collars 25, 26, 27, and 28 used in the frame 200 is McMaster-Carr® Part #9946K24 of McMaster-Carr Supply Company. In the second embodiment, the axles 22a and 22b of the frame 200 for the fixed height floor jack are lowered, for example, by about 6 inches. The frame 200 spreads the center to the center of the axles 22a and 22b, for example, by about 5½ inches compared to conventional floor jacks in the market.

The frame 200 further comprises a set of tire-wheel assemblies (not shown) similar to the tire-wheel assemblies 1003 exemplarily illustrated in FIGS. 10A-10B and FIG. 11. The tire-wheel assemblies are connected to the hubs 210, 211, 212, and 213 to provide mobility to the floor jack 1000 when the floor jack 1000 is assembled. When the frame 200 for the floor jack 1000 is used, for example, with a 5.70-inch to 8-inch tire 1001 and 8 inches—4 on 4-inch wheel/rim 1002, the top of the lifting pad 802 of the floor jack 1000 exemplarily illustrated in FIGS. 10A-10B and FIG. 11, above a substantially horizontal surface on which the floor jack 1000 is positioned, will be at a height of, for example, about 32.5 inches. With reference to the 5.70-inch to 8-inch tire 1001 disclosed above, 5.70 inches is the width of the tire 1001 and 8 inches is the diameter of both the tire 1001 and the wheel/rim 1002. Each of the hubs 210, 211, 212, and 213 comprises a set of parts. That is, the hubs 210, 211, 212, and 213 comprise four-bolt flange bearing 210a, 211a, 212a, and 213a, thick metal spacer plates 210b, 211b, 212b, and 213b, and thick metal end plates 210c, 211c, 212c, and 213c respectively, as exemplarily illustrated in FIG. 21. The hubs 210, 211, 212, and 213 further comprise fasteners (not shown). In the second embodiment, the frame 200 comprises about three spreader bars 23a, 23b, and 23c. The structure and the placement of the spreader bars 23a, 23b, and 23c of the frame 200 in the second embodiment are similar to the structure and the placement of the spreader bars 3a, 3b, and 3c of the frame 100 in the first embodiment as exemplarily illustrated in FIG. 2 and FIGS. 5-7.

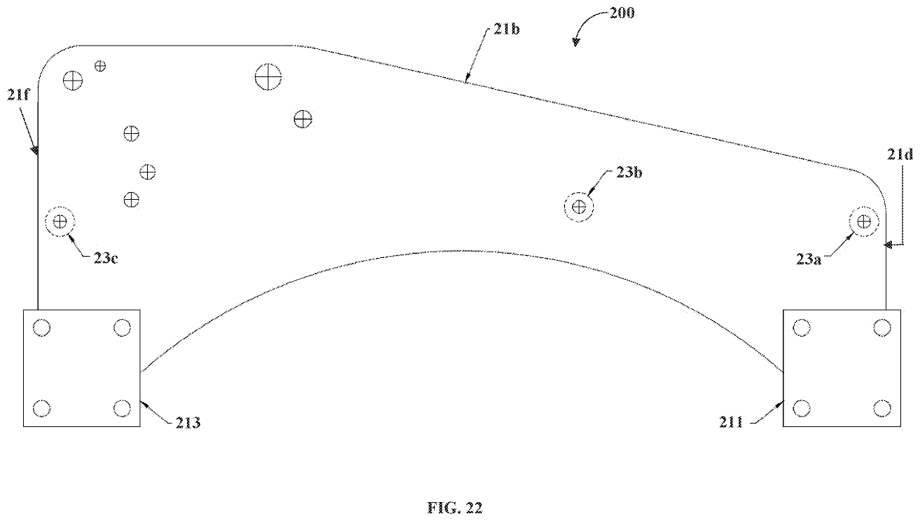

FIG. 22 exemplarily illustrates a side view of the frame 200 of the floor jack 1000 shown in FIGS. 10A-10B and FIG. 11, according to the second embodiment herein. The structure and the function of the parts of the frame 200, for example, the hubs 211 and 213, the spreader bars 23a, 23b, and 23c, etc., shown in FIG. 22 are similar to the structure and the function of the corresponding parts of the frame 100 disclosed in the detailed description of FIG. 3.

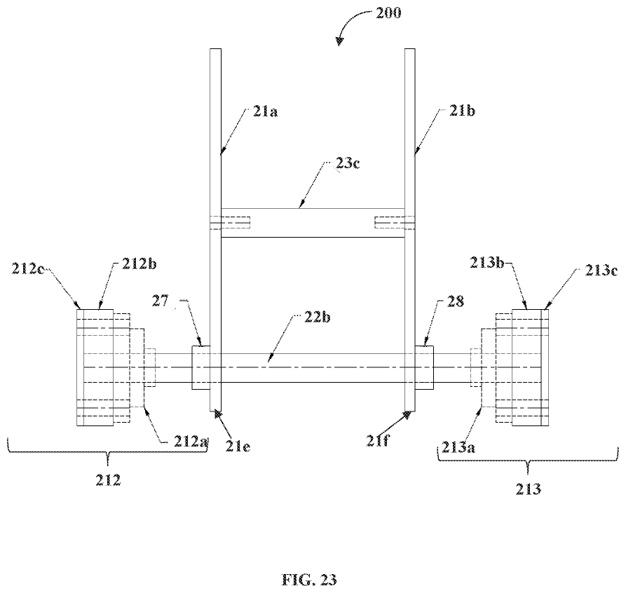

FIG. 23 exemplarily illustrates a rear view of the frame 200 of the floor jack 1000 shown in FIGS. 10A-10B and FIG. 11, according to the second embodiment herein. The structure and the function of the parts of the frame 200, for example, the arched side plates 21a and 21b, the second axle 22b, the hubs 212 and 213, the spreader bar 23c, etc., shown in FIG. 23 are similar to the structure and the function of the corresponding parts of the frame 100 disclosed in the detailed description of FIG. 4.

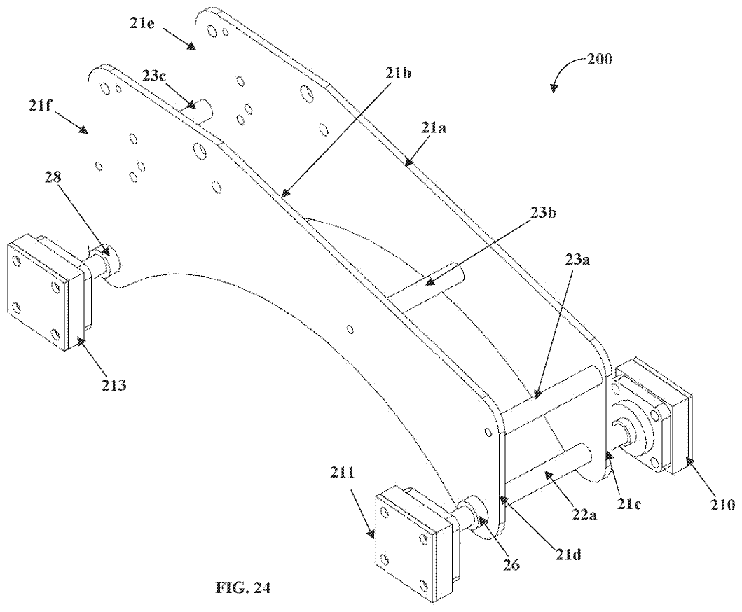

FIG. 24 exemplarily illustrates a perspective view of the frame 200 of the floor jack 1000 shown in FIGS. 10A-10B and FIG. 11, according to the second embodiment herein. The structure and the function of the parts of the frame 200 shown in FIG. 24 are similar to the structure and the function of the corresponding parts of the frame 100 disclosed in the detailed description of FIG. 6.

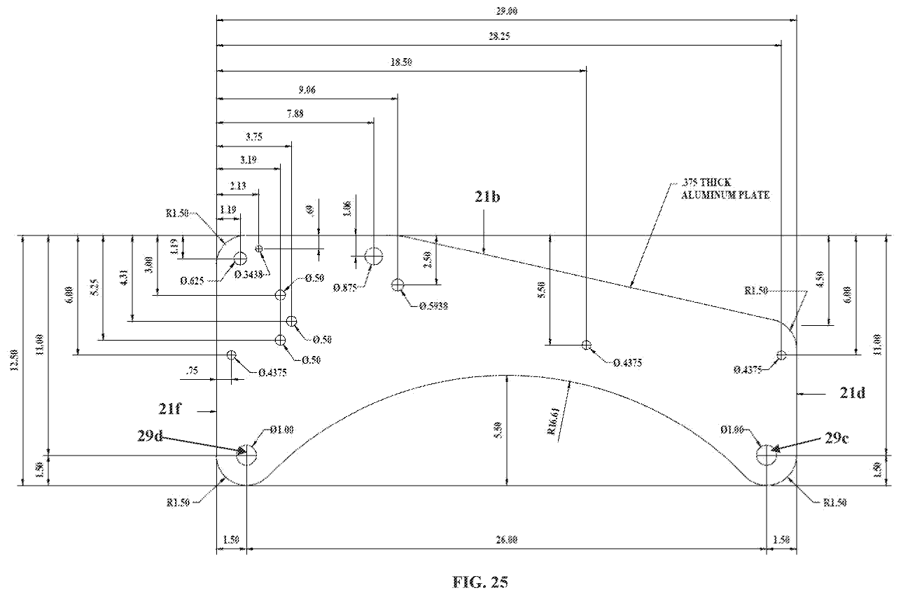

FIG. 25 exemplarily illustrates a dimensional drawing of the arched side plate 21b of the frame 200 of the floor jack 1000 shown in FIGS. 10A-10B and FIG. 11, according to the second embodiment herein. The arched side plate 21b is a replica of the arched side plate 21a exemplarily illustrated in FIG. 24. The structure and the function of the arched side plates 21a and 21b of the frame 200 are similar to the structure and the function of the corresponding parts of the frame 100 disclosed in the detailed description of FIG. 12. As exemplarily illustrated in FIG. 25, the arched side plate 21b comprises lower axle holes 29c and 29d. The arched side plate 21a also comprises lower axle holes (not shown). The width of the arched side plate 21b at the front end 21d is, for example, about 8 inches. The width of the arched side plate 21b at the rear end 21f is, for example, about 12.5 inches.

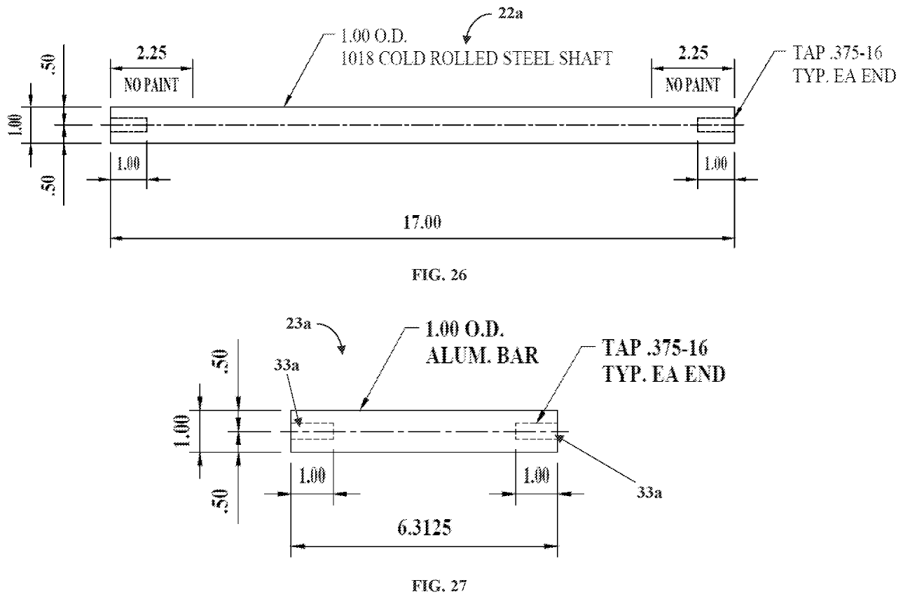

FIG. 26 exemplarily illustrates a dimensional drawing of the axle 22a of the frame 200 of the floor jack 1000 shown in FIGS. 10A-10B and FIG. 11, according to the second embodiment herein. The axle 22b is a replica of the axle 22a exemplarily illustrated in FIG. 21 and FIG. 23. The structure and the function of the axles 22a and 22b of the frame 200 are similar to the structure and the function of the axles 2a and 2b of the frame 100 disclosed in the detailed description of FIG. 13. The length of each of the axles 22a and 22b is, for example, about 17 inches. In an embodiment, the length of each of the axles 22a and 22b is, for example, about 15.75 inches.

FIG. 27 exemplarily illustrates a dimensional drawing of the spreader bar 23a of the frame 200 of the floor jack 1000 shown in FIGS. 10A-10B and FIG. 11, according to the second embodiment herein. The spreader bars 23b and 23c are replicas of the spreader bar 23a. The structure and the function of the spreader bars 23a, 23b, and 23c of the frame 200 are similar to the structure and the function of the spreader bars 3a, 3b, 3c, 3d, and 3e of the frame 100 disclosed in the detailed description of FIG. 14. As exemplarily illustrated in FIG. 27, the spreader bar 23a of the frame 200 comprises threaded holes 33a on both ends thereof corresponding to the threaded holes 13a on the ends of the spreader bar 2a of the frame 100 exemplarily illustrated in FIG. 14.

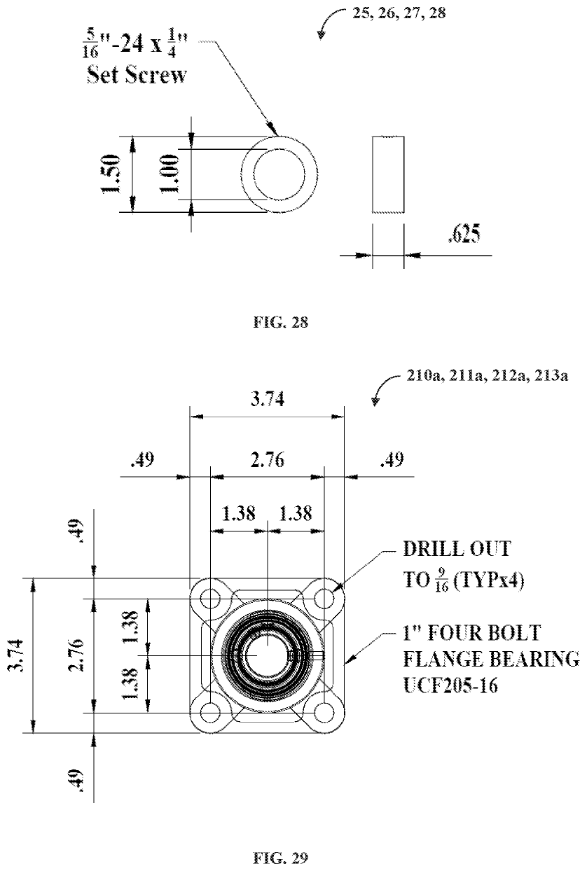

FIG. 28 exemplarily illustrates a dimensional drawing of a non-adjustable collar 25, 26, 27, 28 of the frame 200 of the floor jack 1000 shown in FIGS. 10A-10B and FIG. 11, according to the second embodiment herein. The non-adjustable collars 25, 26, 27, and 28 are fixed shaft collars that secure the arched side plates 21a and 21b to the axles 22a and 22b, and to the hubs 210, 211, 212, and 213 at the front ends 21c and 21d and the rear ends 21e and 21f of the arched side plates 21a and 21b as exemplarily illustrated in FIG. 21. In an embodiment, the fixed shaft collars 25, 26, 27, and 28 are generally circular shaped. In an example, the inner diameter and the outer diameter of each of the four fixed shaft collars 25, 26, 27, and 28 are about 1 inch and about 1.5 inches respectively. The fixed shaft collars 25, 26, 27, and 28 have a thickness of about 0.625 inches.

FIG. 29 exemplarily illustrates a dimensional drawing of the four-bolt flange bearing 210a, 211a, 212a, 213a of each hub 210, 211, 212, 213 respectively, of the frame 200 of the floor jack 1000 shown in FIGS. 10A-10B and FIG. 11, according to the second embodiment herein. The structure and the function of the four-bolt flange bearings 210a, 211a, 212a, and 213a of the hubs 210, 211, 212, and 213 respectively, of the frame 200 are similar to the structure and the function of the four-bolt flange bearings 5a, 6a, 7a, and 8a of their respective hubs 5, 6, 7, and 8 of the frame 100 disclosed in the detailed description of FIG. 16.

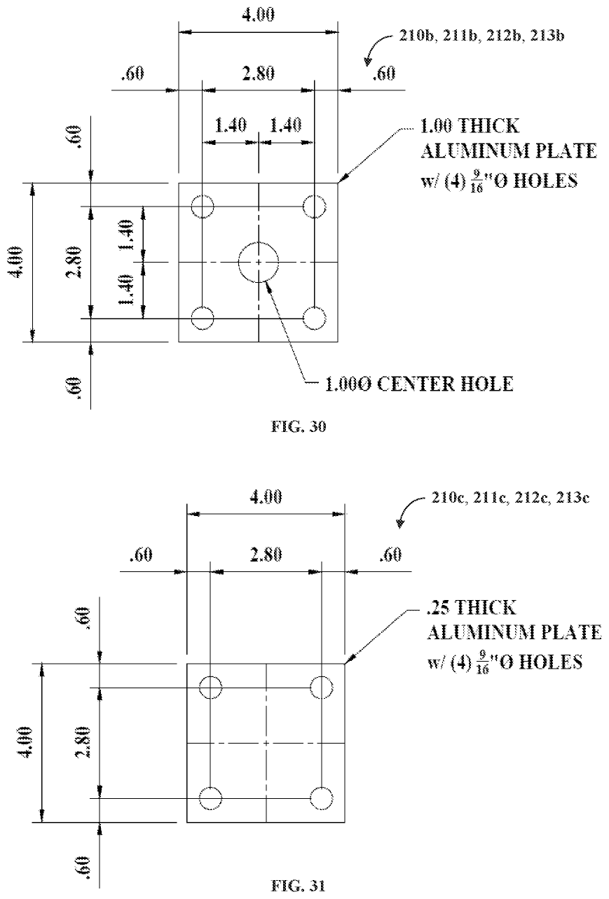

FIG. 30 exemplarily illustrates a dimensional drawing of the spacer plate 210b, 211b, 212b, 213b of each hub 210, 211, 212, 213 respectively, of the frame 200 of the floor jack 1000 shown in FIGS. 10A-10B and FIG. 11, according to the second embodiment herein. In an embodiment, the spacer plates 210b, 211b, 212b, and 213b of the hubs 210, 211, 212, and 213 respectively, are thick metal spacer plates. The structure and the function of the spacer plates 210b, 211b, 212b, and 213b of the hubs 210, 211, 212, and 213 respectively of the frame 200 are similar to the structure and the function of the spacer plates 5b, 6b, 7b, and 8b of their respective hubs 5, 6, 7, and 8 of the frame 100 disclosed in the detailed description of FIG. 17.

FIG. 31 exemplarily illustrates a dimensional drawing of the end plate 210c, 211c, 212c, 213c of each hub 210, 211, 212, 213 respectively, of the frame 200 of the floor jack 1000 shown in FIGS. 10A-10B and FIG. 11, according to the second embodiment herein. The end plates 210c, 211c, 212c, and 213c are thick metal end plates made, for example, of aluminum. The structure and the function of the end plates 210c, 211c, 212c, and 213c of the hubs 210, 211, 212, and 213 respectively of the frame 200 are similar to the structure and the function of the end plates 5c, 6c, 7c, and 8c of their respective hubs 5, 6, 7, and 8 of the frame 100 disclosed in the detailed description of FIG. 18.

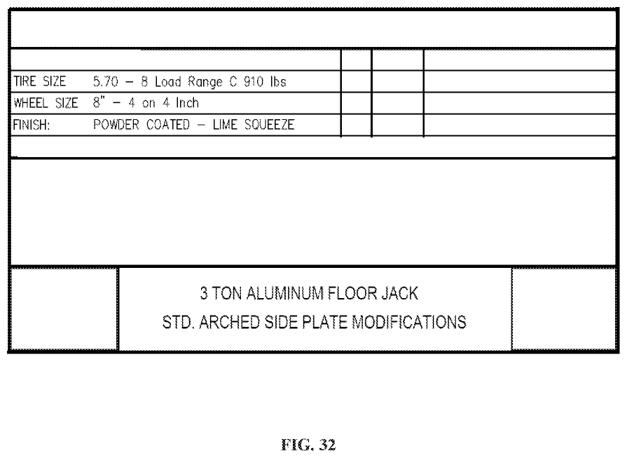

FIG. 32 indicates exemplary sizes of the tire-wheel assembly 1003 of the frame 200 of the floor jack 1000 shown in FIGS. 10A-10B and FIG. 11, according to the second embodiment herein. The tire-wheel assembly 1003 comprises a tire 1001 and a wheel/rim 1002 as exemplarily illustrated in FIGS. 10A-10B and FIG. 11. The tire size and wheel size of the tire-wheel assembly 1003 are exemplarily illustrated in FIG. 32. In an example, the tire-wheel assembly 1003 has a lime squeeze powder coating finish.

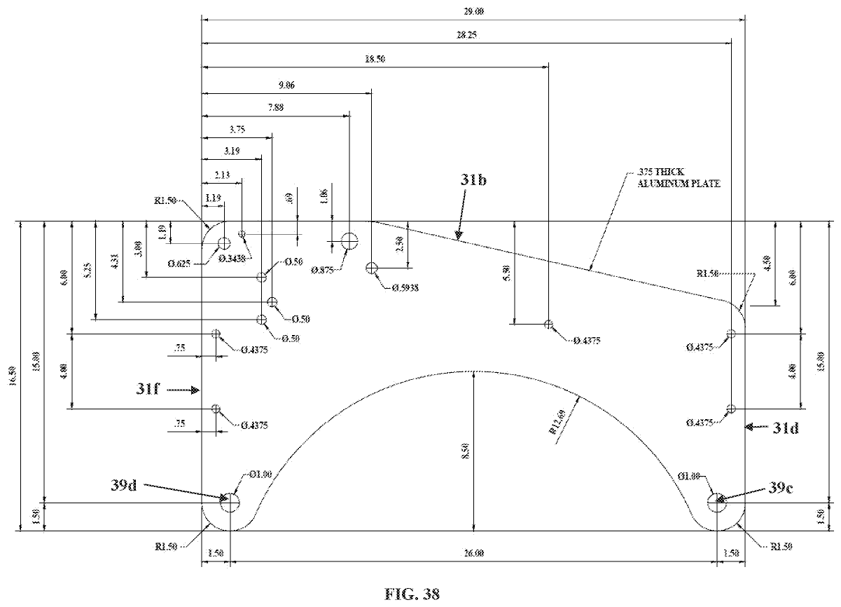

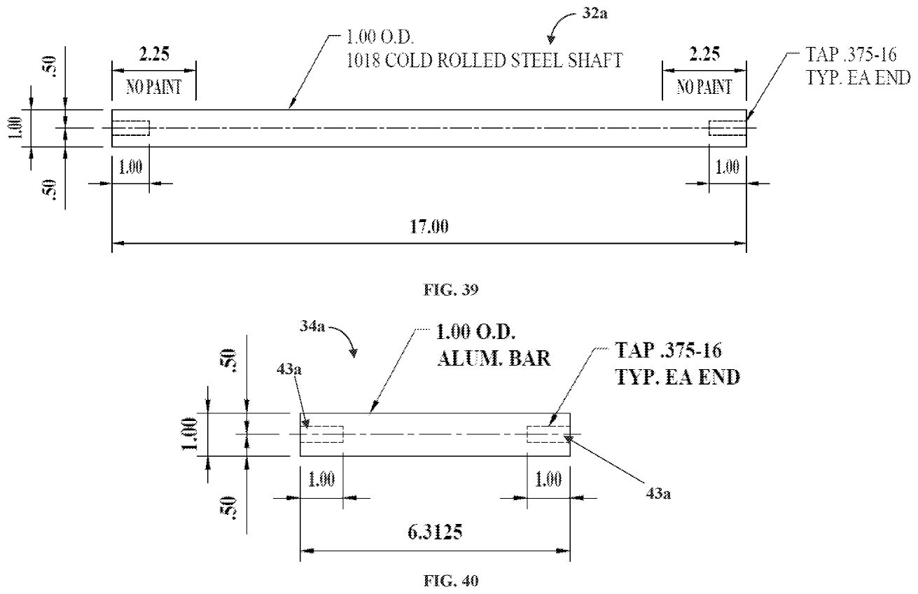

FIGS. 33-45 exemplarily illustrate a third embodiment of the frame 300 for a floor jack 1000 shown in FIGS. 10A-10B and FIG. 11. The third embodiment of the frame 300 is functionally the same as the second embodiment of the frame 200 of the floor jack 1000 exemplarily illustrated in FIGS. 20-24, with some of the components of the frame 300 being of a larger size than those of the frame 200 as disclosed in the detailed descriptions of FIGS. 38-45. FIG. 33 is a tabulation of the different parts of the frame 300 of the floor jack 1000, according to the third embodiment herein. The parts of the frame 300 of the third embodiment are structurally and functionally the same as the parts of the frame 200 of the second embodiment, with the dimensions of some of the parts of the frame 300 being larger than those of the frame 200. For example, while the width of each of the arched side plates 21a and 21b of the frame 200 of the second embodiment is about 12.5 inches at each of the rear ends 21e and 21f and tapers down to about 8 inches at each of the front ends 21c and 21d as exemplarily illustrated in FIG. 25, the width of each of the arched side plates 31a and 31b of the frame 300 of the third embodiment, is about 16.5 inches at the rear ends 31e and 31f and tapers down to about 12 inches at the front ends 31c and 31d as exemplarily illustrated in FIG. 38. Similarly, while the axles 22a and 22b of the frame 200 of the second embodiment are, in an embodiment, about 15.75 inches long as exemplarily illustrated in FIG. 26, the axles 32a and 32b of the frame 300 of the third embodiment are about 17 inches long as exemplarily illustrated in FIG. 39. In an example, because of the longer axles 32a and 32b in the third embodiment of the frame 300, the end-to-end distance between the hubs 310 and 311 at the front ends 31c and 31d of the arched side plates 31a and 31b of the frame 300, and the end-to-end distance between the hubs 312 and 313 at the rear ends 31e and 31f of the arched side plates 31a and 31b of the frame 300 exemplarily illustrated in FIG. 34, are equal to about 17.5 inches. In an example, the end-to-end distance between the hubs 210 and 211 at the front ends 21c and 21d of the arched side plates 21a and 21b of the frame 200, and the end-to-end distance between the hubs 212 and 213 at the rear ends 21e and 21f of the arched side plates 21a and 21b of the frame 200 exemplarily illustrated in FIG. 21, are equal to about 16.25 inches. When the frame 200 of the second embodiment exemplarily illustrated in FIG. 21 is used with a tire-wheel assembly 1003 comprising a 5.70—8-inch tire 1001 and an 8-inch—4 on 4-inch wheel/rim 1002 shown in FIGS. 10A-10B and FIG. 11, the top of the lifting pad 802 of the floor jack 1000 will be at an elevation of, for example, about 32.5 inches above a substantially horizontal surface on which the floor jack 1000 is positioned. When the frame 300 of the third embodiment is used with a tire-wheel assembly 1003 comprising a 175/80-13-inch tire 1001 and 8-inch—4 on 4-inch wheel/rim 1002, the top of the lifting pad 802 of the floor jack 1000 will be at an elevation of, for example, about 40 inches above the substantially horizontal surface on which the floor jack 1000 is positioned.

In the third embodiment, the frame 300 is configured for a mega floor jack with mega arched side plates 31a and 31b that lowers the axles 32a and 32b, for example, by about 10 inches and spreads the center to the center of the axles 32a and 32b, for example, by about 5½ inches. When the frame 300 of the third embodiment is used with a 175/80-13-inch tire 1001 and a 13-inch—4 on 4-inch wheel/rim 1002, the top of the lifting pad 802 of the mega floor jack will be at an elevation of, for example, about 40 inches. In this configuration, the lifting pad 802 is in a retracted position.

FIG. 34 exemplarily illustrates a top view of the frame 300 of the floor jack 1000 shown in FIGS. 10A-10B and FIG. 11, according to the third embodiment herein. The frame 300 comprises the following parts: a pair of arched side plates 31a and 31b, a first pair of hubs 310 and 311, a second pair of hubs 312 and 313, a first axle 32a, a second axle 32b, and a set of spreader bars 34a, 34b, 34c, 34d, and 34e as exemplarily illustrated in FIGS. 34-37. The structure and function of the parts of the frame 300 of the third embodiment are similar to the structure and function of the corresponding parts of the frame 100 of the first embodiment as disclosed in the detailed description of FIG. 2. The frame 300 further comprises non-adjustable shaft collars 35, 36, 37, and 38, the structure and the function of which are disclosed in the detailed description of FIG. 21.

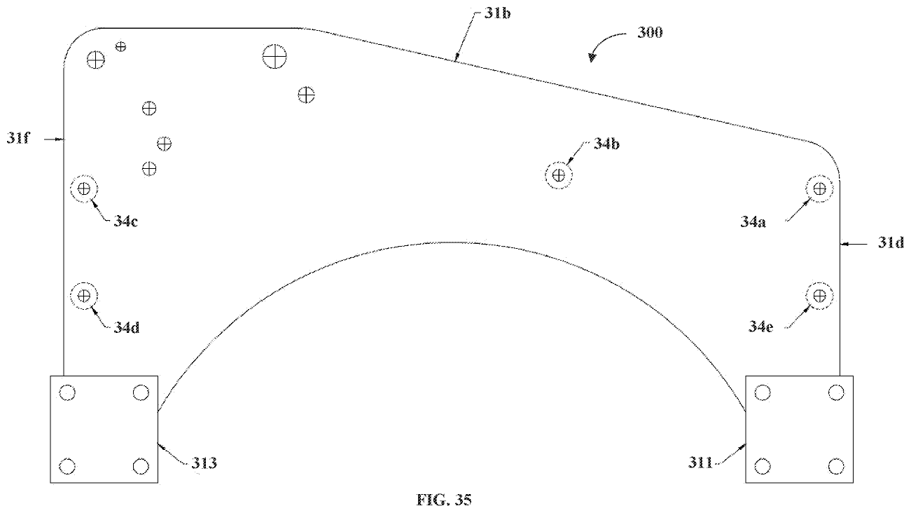

FIG. 35 exemplarily illustrates a side view of the frame 300 of the floor jack 1000 shown in FIGS. 10A-10B and FIG. 11, according to the third embodiment herein. The description for FIG. 35 is similar to the description for FIG. 3. The structure and the function of the parts of the frame 300, for example, the hubs 311 and 313, the spreader bars 34a, 34b, 34c, 34d, and 34e, etc., shown in FIG. 35 are similar to the structure and the function of the corresponding parts of the frame 100 disclosed in the detailed description of FIG. 3.

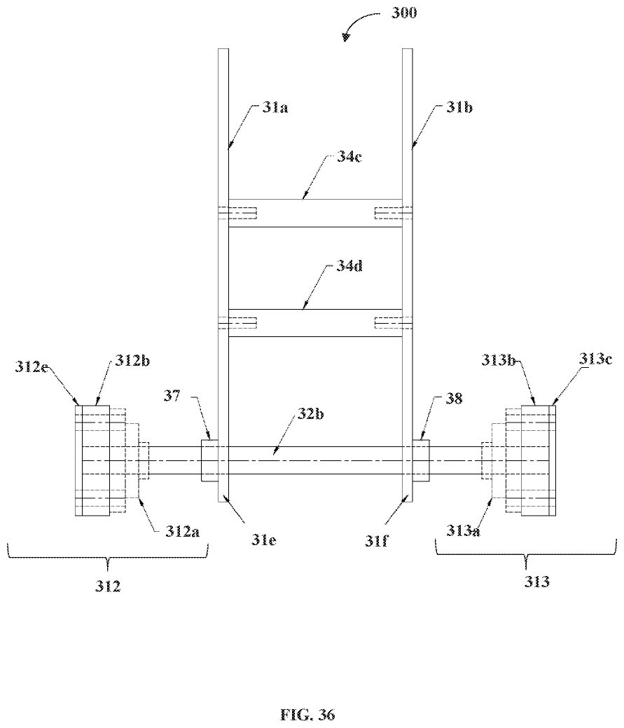

FIG. 36 exemplarily illustrates a rear view of the frame 300 of the floor jack 1000 shown in FIGS. 10A-10B and FIG. 11, according to the third embodiment herein. The structure and the function of the parts of the frame 300, for example, the arched side plates 31a and 31b, the second axle 32b, the hubs 312 and 313, the spreader bars 34c, 34d, etc., shown in FIG. 36 are similar to the structure and the function of the corresponding parts of the frame 100 disclosed in the detailed description of FIG. 4.

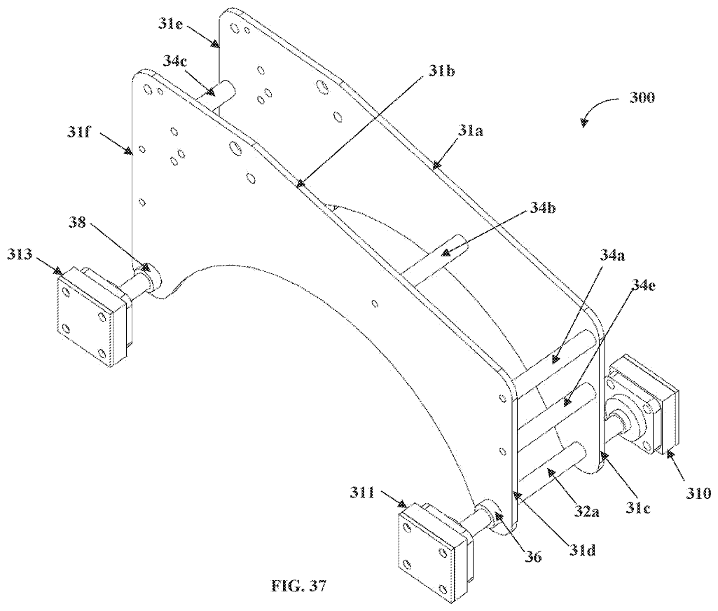

FIG. 37 exemplarily illustrates a perspective view of the frame 300 of the floor jack 1000 shown in FIGS. 10A-10B and FIG. 11, according to the third embodiment herein. The structure and the function of the parts of the frame 300 shown in FIG. 37 are similar to the structure and the function of the corresponding parts of the frame 100 disclosed in the detailed description of FIG. 5.

FIG. 38 exemplarily illustrates a dimensional drawing of the arched side plate 31b of the frame 300 of the floor jack 1000 shown in FIGS. 10A-10B and FIG. 11, according to the third embodiment herein. The arched side plate 31b is a replica of the arched side plate 31a exemplarily illustrated in FIG. 37. The structure and the function of the arched side plates 31a and 31b of the frame 300 are similar to the structure and the function of the corresponding parts of the frame 100 disclosed in the detailed description of FIG. 12. As exemplarily illustrated in FIG. 38, the arched side plate 31b comprises lower axle holes 39c and 39d. The arched side plate 31a also comprises lower axle holes (not shown). The width of the arched side plate 31b at the front end 31d is, for example, about 12 inches. The width of the arched side plate 31b at the rear end 31f is, for example, about 16.5 inches.

FIG. 39 is a dimensional drawing of the axle 32a of the frame 300 of the floor jack 1000 shown in FIGS. 10A-10B and FIG. 11, according to the third embodiment herein. The axle 32b is a replica of the axle 32a exemplarily illustrated in FIG. 34 and FIG. 37. The structure and the function of the axles 32a and 32b of the frame 300 are similar to the structure and the function of the axles 2a and 2b of the frame 100 disclosed in the detailed description of FIG. 13. The length of each of the axles 32a and 32b is, for example, about 17 inches.

FIG. 40 exemplarily illustrates a dimensional drawing of the spreader bar 34a of the frame 300 of the floor jack 1000 shown in FIGS. 10A-10B and FIG. 11, according to the third embodiment herein. The spreader bars 34b, 34c, 34d, and 34e are replicas of the spreader bar 34a. The structure and the function of the spreader bars 34a, 34b, 34c, 34d, and 34e of the frame 300 are similar to the structure and the function of the spreader bars 3a, 3b, 3c, 3d, and 3e of the frame 100 disclosed in the detailed description of FIG. 14. As exemplarily illustrated in FIG. 40, the spreader bar 34a of the frame 300 comprises threaded holes 43a on both ends thereof corresponding to the threaded holes 33a on the ends of the spreader bar 23a of the frame 200 exemplarily illustrated in FIG. 27.

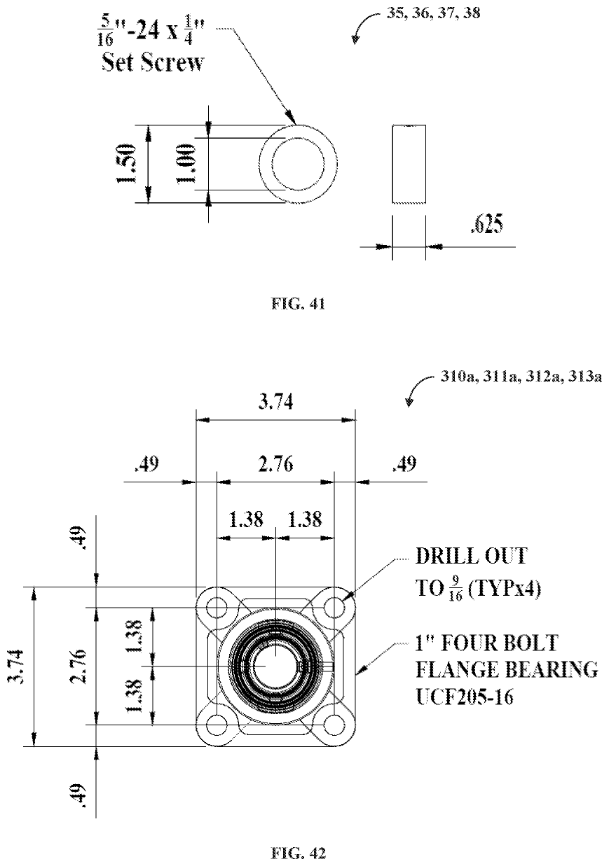

FIG. 41 exemplarily illustrates a dimensional drawing of the non-adjustable collar 35, 36, 37, 38 of the frame 300 of the floor jack 1000 shown in FIGS. 10A-10B and FIG. 11, according to the third embodiment herein. The structure and the function of the non-adjustable collars 35, 36, 37, and 38 of the frame 300 are similar to the structure and the function of the non-adjustable collars 25, 26, 27, and 28 of the frame 200 disclosed in the detailed description of FIG. 28.

FIG. 42 exemplarily illustrates a dimensional drawing of the four-bolt flange bearing 310a, 311a, 312a, 313a of each hub 310, 311, 312, 313 of the frame 300 of the floor jack 1000 shown in FIGS. 10A-10B and FIG. 11, according to the third embodiment herein. The structure and the function of the four-bolt flange bearings 310a, 311a, 312a, and 313a of the hubs 310, 311, 312, and 313 respectively of the frame 300 are similar to the structure and the function of the four-bolt flange bearings 5a, 6a, 7a, and 8a of their respective hubs 5, 6, 7, and 8 of the frame 100 disclosed in the detailed description of FIG. 16.

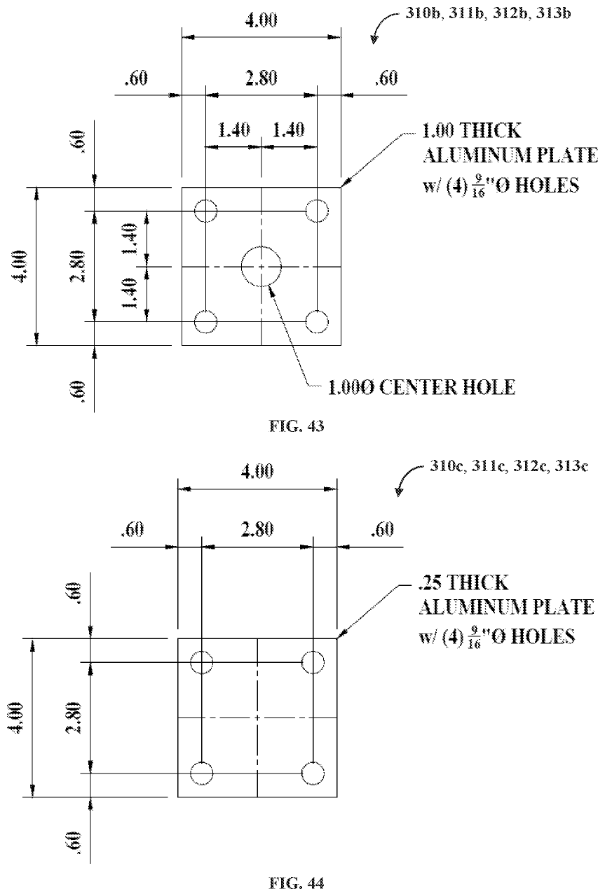

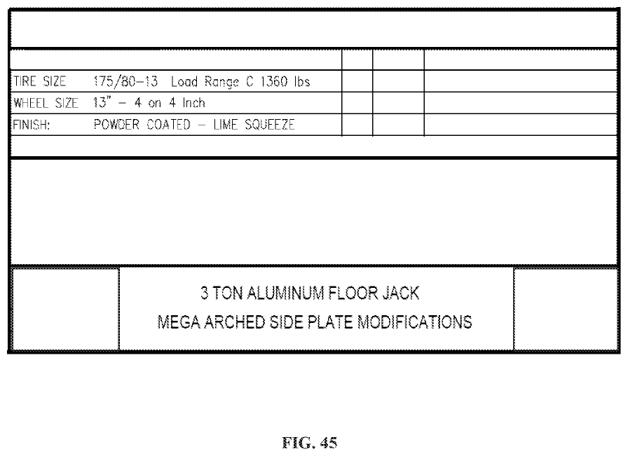

FIG. 43 exemplarily illustrates a dimensional drawing of the spacer plate 310b, 311b, 312b, and 313b of each hub 310, 311, 312, 313 of the frame 300 of the floor jack 1000 shown in FIGS. 10A-10B and FIG. 11, according to the third embodiment herein. In an embodiment, the spacer plates 310b, 311b, 312b, and 313b of the hubs 310, 311, 312, and 313 respectively, are thick metal spacer plates. The structure and the function of the spacer plates 310b, 311b, 312b, and 313b of the hubs 310, 311, 312, and 313 respectively of the frame 300 are similar to the structure and the function of the spacer plates 5b, 6b, 7b, and 8b of their respective hubs 5, 6, 7, and 8 of the frame 100 disclosed in the detailed description of FIG. 17.

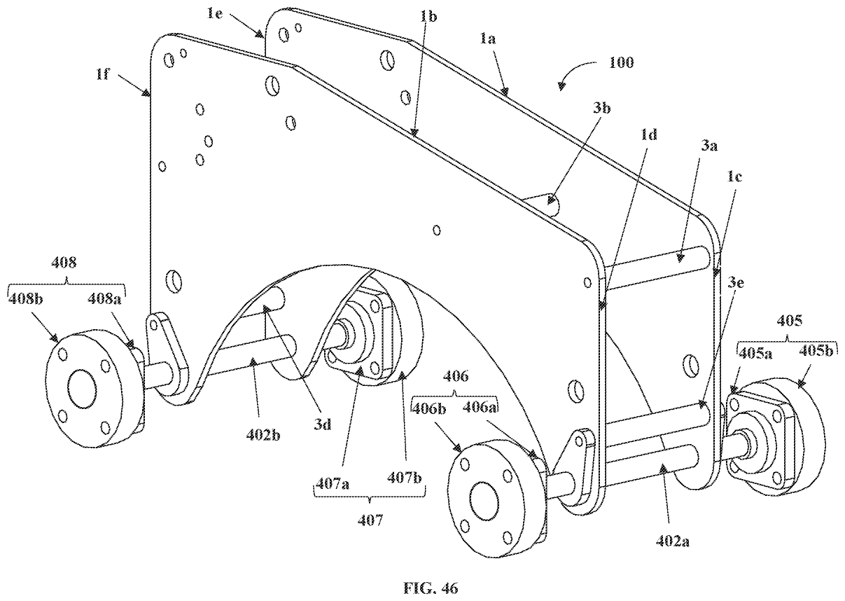

FIG. 44 exemplarily illustrates a dimensional drawing of the end plate 310c, 311c, 312c, and 313c of each hub 310, 311, 312, 313 of the frame 300 of the floor jack 1000 shown in FIGS. 10A-10B and FIG. 11, according to the third embodiment herein. The end plates 310c, 311c, 312c, and 313c are thick metal end plates made, for example, of aluminum. The structure and the function of the end plates 310c, 311c, 312c, and 313c of the hubs 310, 311, 312, and 313 respectively of the frame 300 are similar to the structure and the function of the end plates 5c, 6c, 7c, and 8c of their respective hubs 5, 6, 7, and 8 of the frame 100 disclosed in the detailed description of FIG. 18.

FIG. 45 indicates exemplary sizes of a tire-wheel assembly 1003 of the frame 300 of the floor jack 1000 shown in FIGS. 10A-10B and FIG. 11, according to the third embodiment herein. The tire-wheel assembly 1003 comprises a tire 1001 and a wheel/rim 1002 as exemplarily illustrated in FIGS. 10A-10B and FIG. 11. The tire size and wheel size of the tire-wheel assembly 1003 are exemplarily illustrated in FIG. 45. In an example, the tire-wheel assembly 1003 has a lime squeeze powder coating finish. All the three embodiments of the frame 100, 200, and 300 shown in FIG. 2, FIG. 21, and FIG. 34 respectively, are configured for 3-ton factory floor jacks that have a vertical stroke of, for example, about 16 inches for the lifting pad 802 exemplarily illustrated in FIGS. 10A-10B and FIG. 11.

The teardrop-shaped adjustable shaft collars 15, 16, 17, and 18 of the frame 100 of the first embodiment, provide benefits of both the frame 200 of the second embodiment and the frame 300 of the third embodiment for the floor jack 1000. In the first embodiment exemplarily illustrated in FIG. 2 and FIG. 7, when the axles 2a and 2b are positioned in the lower axle holes 9a, 9c and 9b, 9d, respectively, of the arched side plates 1a and 1b, and the teardrop-shaped adjustable shaft collars 15, 16, 17, and 18 are in a lower position 1501 as exemplarily illustrated in FIG. 6, FIGS. 9A-9B, and FIG. 15B, then the resulting frame forms and operates similar to the frame 200 of the second embodiment. Likewise, in the first embodiment, when the axles 2a and 2b are positioned in the upper axle holes 14a, 14c and 14b, 14d, respectively, of the arched side plates 1a and 1b, and the teardrop-shaped adjustable shaft collars 15, 16, 17, and 18 are in an upper position 1503 as exemplarily illustrated in FIG. 5, FIGS. 8A-8B, and FIG. 15B, then the resulting frame forms and operates similar to the frame 300 configured for a mega floor jack of the third embodiment.

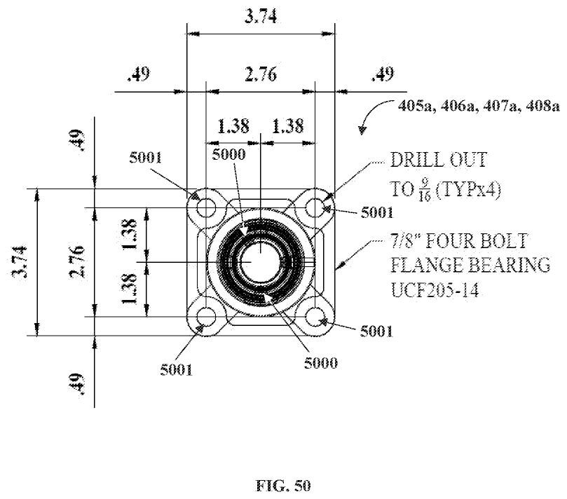

FIG. 46 exemplarily illustrates a perspective view of the frame 100 of the floor jack 1000 shown in FIGS. 10A-10B and FIG. 11, according to the first embodiment herein, showing embodiments of the four-bolt flange bearings 405a, 406a, 407a, and 408a, the spacer plates 405b, 406b, 407b, and 408b, and the axles 402a and 402b. The frame 100 exemplarily illustrated in FIG. 46, comprise different embodiments of the hubs 405, 406, 407, and 408 and the axles 402a and 402b. In an embodiment, the four-bolt flange bearings 405a, 406a, 407a, and 408a are, for example, UCF205-14, ⅞-inch four-bolt flange bearings as exemplarily illustrated in FIG. 50. In an embodiment, the thick metal spacer plates 405b, 406b, 407b, and 408b of the respective hubs 405, 406, 407, and 408 of the frame 100 exemplarily illustrated in FIG. 46, are circular in shape as opposed to the square-shaped thick metal spacer plates 5b, 6b, 7b, and 8b exemplarily illustrated in FIGS. 2-9B, FIG. 11, and FIG. 17. The hubs 405 and 406 comprising the thick metal spacer plates 405b and 406b respectively, and the four-bolt flange bearings 405a and 406a respectively, are secured to the first axle 402a using one or more set screws 5000 exemplarily illustrated in FIG. 50. The hubs 407 and 408 comprising the thick metal spacer plates 407b and 408b respectively, and the four-bolt flange bearings 407a and 408a respectively, are secured to the second axle 402b using one or more set screws 5000.

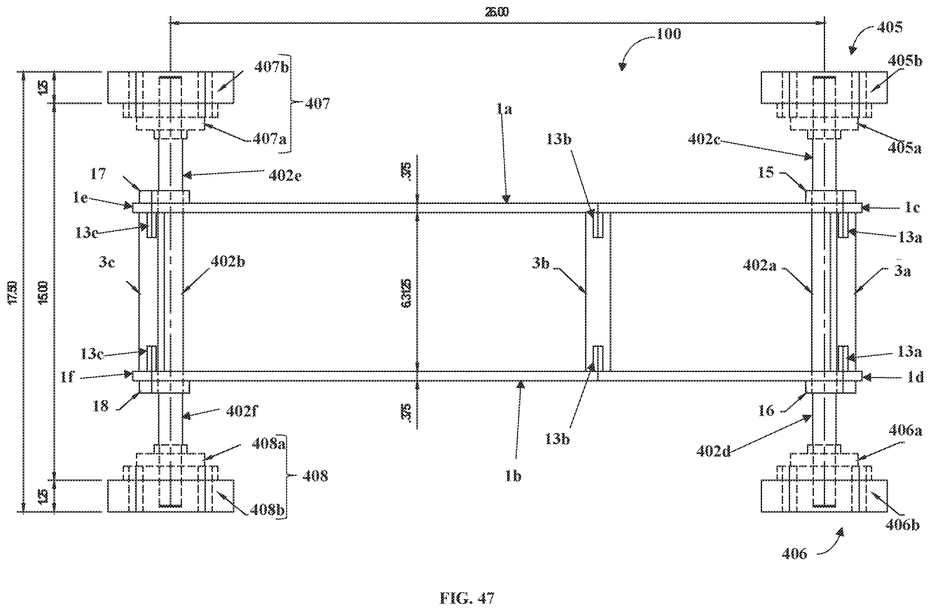

FIG. 47 exemplarily illustrates a top view of the frame 100 of the floor jack shown in FIG. 46. The frame 100 comprises a pair of arched side plates 1a and 1b, adjustable collars 15, 16, 17, and 18, and a set of spreader bars 3a, 3b, 3c, 3d, and 3e as disclosed in the detailed descriptions of FIGS. 2-3, FIG. 12, FIG. 14, and FIGS. 15A-15B. The frame 100 further comprises different embodiments of the first pair of hubs 405 and 406, the second pair of hubs 407 and 408, the first axle 402a, and the second axle 402b as disclosed in the detailed description of FIG. 46. The distance between the arched side plates 1a and 1b is, for example, about 6.3125 inches. The end-to-end distance between the first pair of hubs 405 and 406 is, for example, about 17.5 inches. The end-to-end distance between the second pair of hubs 407 and 408 is, for example, about 17.5 inches. Other exemplary dimensions are exemplarily illustrated in FIG. 47.

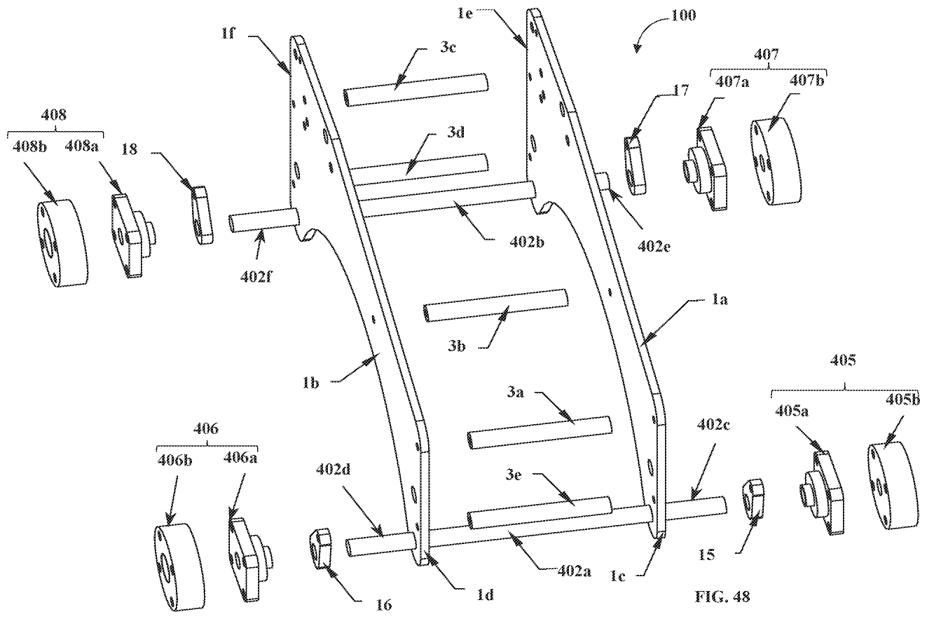

FIG. 48 exemplarily illustrates an exploded view of the frame 100 of the floor jack shown in FIG. 46. FIG. 48 exemplarily illustrates the positions of the spreader bars 3a, 3b, 3c, 3d, and 3e between the arched side plates 1a and 1b, the axles 402a and 402b, and the constituents, namely, the four-bolt flange bearings 405a, 406a, 407a, and 408a and the spacer plates 405b, 406b, 407b, and 408b of the respective hubs 405, 406, 407, and 408.

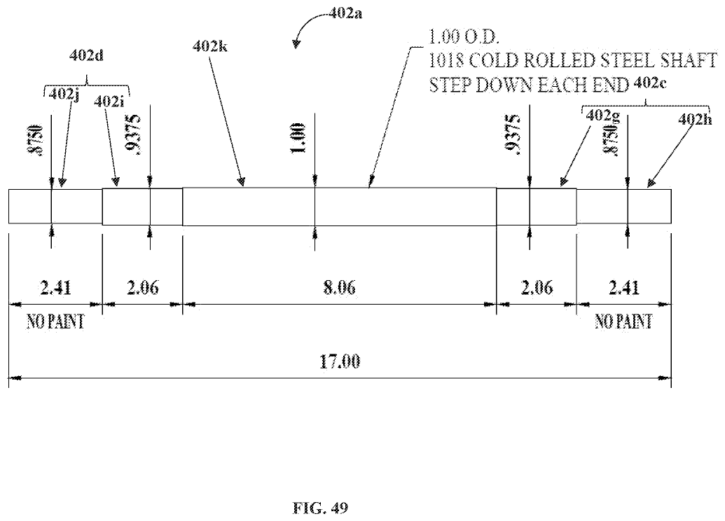

FIG. 49 exemplarily illustrates a dimensional drawing of an axle, that is, the first axle 402a of the frame 100 of the floor jack shown in FIG. 46, according to an embodiment herein. As exemplarily illustrated in FIG. 49, the ends 402c and 402d of the first axle 402a comprise stepped outer sections 402h and 402j respectively, and stepped inner sections 402g and 402i respectively. As exemplarily illustrated in FIG. 49, the diameters of the stepped outer sections 402h and 402j are lesser than the diameters of the stepped inner sections 402g and 402i. Furthermore, the diameter of a mid-section 402k of the first axle 402a is greater than the diameters of the stepped outer sections 402h and 402j and the stepped inner sections 402g and 402i. The structure of the second axle 402b exemplarily illustrated in FIGS. 46-48, is the same as the structure of the first axle 402a. The ends 402e and 402f of the second axle 402b also comprise stepped outer sections and stepped inner sections, similar to the stepped outer sections 402h and 402j and the stepped inner sections 402g and 402i on the ends 402c and 402d of the first axle 402a respectively. In an embodiment, the stepped inner sections 402g and 402i of the first axle 402a accommodate the teardrop-shaped adjustable shaft collars 15 and 16 exemplarily illustrated in FIGS. 46-48. The stepped outer sections 402h and 402j accommodate the hubs 405 and 406 respectively. Similarly, the stepped inner sections of the second axle 402b accommodate the teardrop-shaped adjustable shaft collars 17 and 18 exemplarily illustrated in FIGS. 46-48, and the stepped outer sections of the second axle 402b accommodate the hubs 407 and 408. The length of each of the axles 402a and 402b is, for example, about 17 inches. The diameter of each of the axles 402a and 402b is, for example, about 1 inch. Other exemplary dimensions of the stepped inner sections 402g and 402i, the stepped outer sections 402h and 402j, and the mid-section 402k of the first axle 402a are exemplarily illustrated in FIG. 49. Each of the axles 402a and 402b is configured, for example, as a 1018 cold rolled steel shaft.

FIG. 50 exemplarily illustrates a dimensional drawing of a four-bolt flange bearing 405a, 406a, 407a, 408a of each hub 405, 406, 407, 408 of the frame 100 of the floor jack shown in FIG. 46, according to an embodiment herein. The structure and the function of the four-bolt flange bearings 405a, 406a, 407a, and 408a of the hubs 405, 406, 407, and 408 respectively, of the frame 100 are similar to the structure and the function of the four-bolt flange bearings 5a, 6a, 7a, and 8a of their respective hubs 5, 6, 7, and 8 of the frame 100 disclosed in the detailed description of FIG. 16. Each of the four-bolt flange bearings 405a, 406a, 407a, and 408a is, for example, a UCF205-14, ⅞-inch four-bolt flange bearing comprising set screws 5000 as disclosed in the detailed description of FIG. 46. Each of the four-bolt flange bearings 405a, 406a, 407a, and 408a further comprises drill holes 5001 drilled out, for example, to about 9/16 inches, as disclosed in the detailed description of FIG. 16.

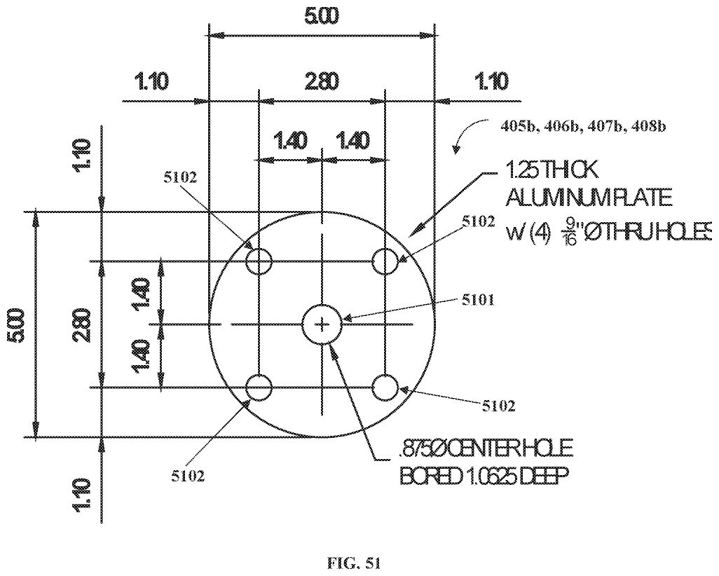

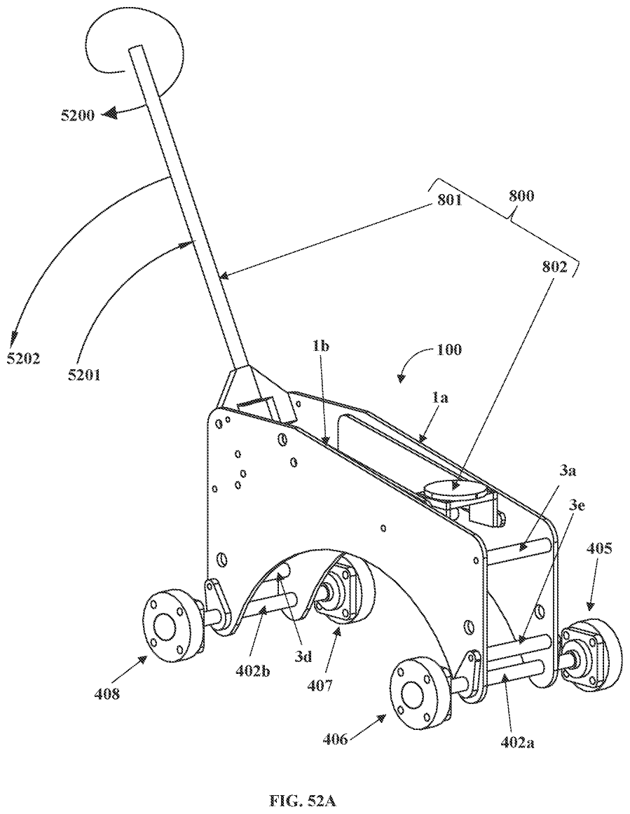

FIG. 51 exemplarily illustrates a dimensional drawing of a thick metal spacer plate 405b, 406b, 407b, 408b of each hub 405, 406, 407, 408 of the frame 100 of the floor jack shown in FIG. 46, according to an embodiment herein. As exemplarily illustrated in FIG. 51, the thick metal spacer plates 405b, 406b, 407b, and 408b of the respective hubs 405, 406, 407, and 408 exemplarily illustrated in FIGS. 46-48, are of a generally circular shape. The thickness of each of the thick metal spacer plates 405b, 406b, 407b, and 408b is, for example, about 1.25 inches. Each of the thick metal spacer plates 405b, 406b, 407b, and 408b comprises a center hole 5101 through which an end of a corresponding axle is connected. For example, the ends 402c and 402d of the first axle 402a exemplarily illustrated in FIGS. 47-48, are inserted through the center holes 5101 of the respective spacer plates 405b and 406b via the respective four-bolt flange bearings 405a and 406a to connect the first axle 402a to the hubs 405 and 406. Similarly, the ends 402e and 402f of the second axle 402b exemplarily illustrated in FIGS. 47-48, are inserted through the center holes 5101 of the respective spacer plates 407b and 408b via the four-bolt flange bearings 407a and 408a to connect the second axle 402b to the hubs 407 and 408. The diameter of the center hole 5101 is, for example, about 0.875 inches. In an embodiment, the center hole 5101 is bored, for example, to about 1.0625 inches deep. In an embodiment, each of the thick metal spacer plates 405b, 406b, 407b, and 408b further comprises four through holes 5102 having, for example, about 9/16-inch diameters. The through holes 5102 of each of the thick metal spacer plates 405b, 406b, 407b, and 408b are aligned coaxial to the drill holes 5001 of the four-bolt flange bearings 405a, 406a, 407a, and 408a respectively, exemplarily illustrated in FIG. 50. Fasteners (not shown) are inserted through the drill holes 5001 of the four-bolt flange bearings 405a, 406a, 407a, and 408a and the through holes 5102 of the thick metal spacer plates 405b, 406b, 407b, and 408b for fastening the four-bolt flange bearings 405a, 406a, 407a, and 408a exemplarily illustrated in FIG. 48, to the thick metal spacer plates 405b, 406b, 407b, and 408b respectively, in their respective hubs 405, 406, 407, and 408.

FIG. 52A exemplarily illustrates a perspective view of the frame 100 of the floor jack shown in FIG. 46, illustrating movement of a handle 801 of a lifting mechanism 800 of the floor jack 1000 shown in FIGS. 10A-10B and FIG. 11, to raise a lifting pad 802 of the lifting mechanism 800, according to an embodiment herein. In FIG. 52A, the elevation of the frame 100 of the floor jack 1000 is shown in the lower position and the lifting pad 802 of the lifting mechanism 800 is shown in a lowered position or a retracted position.

FIG. 52B exemplarily illustrates a perspective view of the frame 100 of the floor jack shown in FIG. 46, illustrating movement of the handle 801 of the lifting mechanism 800 to lower the lifting pad 802 of the lifting mechanism 800, according to an embodiment herein. In FIG. 52B, the elevation of the frame 100 of the floor jack 1000 shown in FIGS. 10A-10B and FIG. 11, is shown in the lower position and the lifting pad 802 of the lifting mechanism 800 is shown in an extended position. In an embodiment, the lifting mechanism 800 is a hydraulic lifting mechanism 800. The lifting pad 802 is raised as disclosed in the detailed description of FIG. 11. When the handle 801 is lowered in a direction 5202 and raised in a direction 5201 exemplarily illustrated in FIG. 52A, liquid is forced into the working cylinder 804 exemplarily illustrated in FIG. 11, by the pump plunger 805, causing the lifting pad 802 to rise up to the extended position as disclosed in the detailed description of FIG. 11. The lifting pad 802 is also raised by rotating the handle 801 in a clockwise direction 5200 as exemplarily illustrated FIG. 52A, until the handle 801 stops rotating. To lower the lifting pad 802, the handle 801 is rotated in counterclockwise direction 5203 as exemplarily illustrated in FIG. 52B. The handle 801 is rotated in a counterclockwise direction 5203 until the lifting pad 802 starts to lower on its own.

The foregoing examples and illustrative implementations of various embodiments of the frame 100, 200, and 300 for the floor jack 1000 have been provided merely for explanation and are in no way to be construed as limiting of the embodiments disclosed herein. Dimensions of the parts of the frames 100, 200, and 300 and the floor jack 1000 disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods, and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A frame for a floor jack, the frame comprising:
a pair of arched side plates, each of the arched side plates comprising a front end and a rear end;
a first pair of hubs positioned at front ends of the pair of arched side plates;
a second pair of hubs positioned at rear ends of the pair of arched side plates;
a first axle connecting the pair of arched side plates to the first pair of hubs at the front ends using a first pair of adjustable collars;
a second axle connecting the pair of arched side plates to the second pair of hubs at the rear ends using a second pair of adjustable collars; and
a set of spreader bars separating the pair of arched side plates along a length of the pair of arched side plates.

2. The frame of claim 1, wherein the first pair of adjustable collars and the second pair of adjustable collars are teardrop-shaped adjustable shaft collars, and wherein the teardrop-shaped adjustable shaft collars are configured to adjust an elevation of a lifting pad of the floor jack, above a substantially horizontal surface on which the floor jack is positioned, between a lowered position and a fully extended position.

3. The frame of claim 2, wherein each of the teardrop-shaped adjustable shaft collars pivots about a pivot point to switch between a lower position and an upper position, to adjust the elevation of the lifting pad of the floor jack.

4. The frame of claim 3, wherein each of the arched side plates comprises upper axle holes and lower axle holes corresponding to the upper position and the lower position of the teardrop-shaped adjustable shaft collars respectively, to allow adjustment of the elevation of the lifting pad of the floor jack.

5. The frame of claim 1, wherein the pair of arched side plates is made of metal and is powder coated.

6. The frame of claim 1, wherein each hub of the first pair of hubs and the second pair of hubs comprises a four-bolt flange bearing, a spacer plate, and an end plate coaxially positioned on either end of the first axle and the second axle respectively.

7. The frame of claim 1, further comprising a set of tire-wheel assemblies, wherein one of the tire-wheel assemblies is connected to each hub of the first pair of hubs and the second pair of hubs to provide mobility to the floor jack when the floor jack is assembled.

8. A frame for a fixed height floor jack, the frame comprising:
a pair of arched side plates, each of the arched side plates comprising a front end and a rear end;
a first pair of hubs positioned at front ends of the pair of arched side plates;
a second pair of hubs positioned at rear ends of the pair of arched side plates;
a first axle connecting the pair of arched side plates to the first pair of hubs at the front ends using a first pair of non-adjustable collars;
a second axle connecting the pair of arched side plates to the second pair of hubs at the rear ends using a second pair of non-adjustable collars; and
a set of spreader bars separating the pair of arched side plates along a length of the pair of arched side plates.

9. The frame of claim 8, wherein the first pair of non-adjustable collars and the second pair of non-adjustable collars are fixed metal shaft collars.

10. The frame of claim 8, wherein the pair of arched side plates is made of thick metal and is powder coated.

11. The frame of claim 8, wherein each hub of the first pair of hubs and the second pair of hubs comprises a four-bolt flange bearing, a spacer plate, and an end plate coaxially positioned on either end of the first axle and the second axle respectively.

12. The frame of claim 8, further comprising a set of tire-wheel assemblies, wherein one of the tire-wheel assemblies is connected to each hub of the first pair of hubs and the second pair of hubs to provide mobility to the floor jack when the floor jack is assembled.

13. A floor jack comprising:
a pair of arched side plates, each of the arched side plates comprising a front end and a rear end;
a first pair of hubs positioned at front ends of the pair of arched side plates;
a second pair of hubs positioned at rear ends of the pair of arched side plates;
a first axle connecting the pair of arched side plates to the first pair of hubs at the front ends using a first pair of adjustable collars;
a second axle connecting the pair of arched side plates to the second pair of hubs at the rear ends using a second pair of adjustable collars;
a set of spreader bars separating the pair of arched side plates along a length of the pair of arched side plates;
a lifting mechanism comprising a lifting pad positioned between the pair of arched side plates; and
a set of tire-wheel assemblies, wherein one of the tire-wheel assemblies is connected to each hub of the first pair of hubs and the second pair of hubs to provide mobility to the floor jack when the floor jack is assembled.

14. The floor jack of claim 13, wherein the first pair of adjustable collars and the second pair of adjustable collars are teardrop-shaped adjustable shaft collars, and wherein the teardrop-shaped adjustable shaft collars are configured to adjust an elevation of a lifting pad of the floor jack, above a substantially horizontal surface on which the floor jack is positioned, between a lowered position and a fully extended position.

15. The floor jack of claim 14, wherein each of the teardrop-shaped adjustable shaft collars pivots about a pivot point to switch between a lower position and an upper position, to adjust the elevation of the lifting pad of the floor jack, and wherein each of the arched side plates comprises upper axle holes and lower axle holes corresponding to the upper position and the lower position of the teardrop-shaped adjustable shaft collars respectively, to allow adjustment of the elevation of the lifting pad of the floor jack.

16. The floor jack of claim 13, wherein each hub of the first pair of hubs and the second pair of hubs comprises a four-bolt flange bearing, a spacer plate, and an end plate coaxially positioned on either end of the first axle and the second axle respectively.

17. The floor jack of claim 13, wherein the lifting mechanism further comprises a handle operably connected to the pair of arched side plates and configured to one of raise the lifting pad to an extended position and lower the lifting pad to a lowered position.

18. A floor jack comprising:
a pair of arched side plates, each of the arched side plates comprising a front end and a rear end;
a first pair of hubs positioned at front ends of the pair of arched side plates;
a second pair of hubs positioned at rear ends of the pair of arched side plates;
a first axle connecting the pair of arched side plates to the first pair of hubs at the front ends using a first pair of non-adjustable collars;
a second axle connecting the pair of arched side plates to the second pair of hubs at the rear ends using a second pair of non-adjustable collars;
a set of spreader bars separating the pair of arched side plates along a length of the pair of arched side plates;
a lifting mechanism comprising a lifting pad positioned between the pair of arched side plates; and
a set of tire-wheel assemblies, wherein one of the tire-wheel assemblies is connected to each hub of the first pair of hubs and the second pair of hubs to provide mobility to the floor jack when the floor jack is assembled.

19. The floor jack of claim 18, wherein each hub of the first pair of hubs and the second pair of hubs comprises a four-bolt flange bearing, a spacer plate, and an end plate coaxially positioned on either end of the first axle and the second axle respectively.

20. The floor jack of claim 18, wherein the lifting mechanism further comprises a handle operably connected to the pair of arched side plates and configured to one of raise the lifting pad to an extended position and lower the lifting pad to a lowered position.
